(19) United States
(12) Patent Application Publication
(10) Pub. No.: US 2026/0329198 A1
(43) Pub. Date: Oct. 22, 2026

(54) DEVELOPING APPARATUS

(71) Applicant: CANON KABUSHIKI KAISHA, Tokyo (JP)

(72) Inventors: Naoki Maeda, Shizuoka (JP); Makoto Hayashida, Shizuoka (JP); Ryuta Murakami, Shizuoka (JP)

(21) Appl. No.: 19/556,233

(22) Filed: Mar. 4, 2026

(30) Foreign Application Priority Data
Mar. 6, 2025 (JP) 2025-035941

(51) Int. Cl. G03G 15/08; G01F 23/26; G03G 15/00

(52) U.S. Cl. CPC G03G 15/0856; G01F 23/26; G03G 15/0808; G03G 15/0889; G03G 15/556; G03G 15/80

(57) ABSTRACT

A developing apparatus, includes a frame having a storage portion for storing developer; first and second electrode portions for detecting electrostatic capacity inside the storage portion; a rotation shaft rotating about a rotational axis in a first direction; a sheet having: a fixed end fixed to the rotation shaft and a free end opposite the fixed end in a second direction orthogonal to the rotational axis. The sheet has a length capable of contacting an inner wall of the frame. A part of the inner wall has a recessed portion that is recessed in a direction away from the rotation shaft in the second direction. The first and second electrode portions are provided in the recessed portion. A width of the recessed portion is narrower than a width of a stirring sheet. The recessed portion is positioned within a region between both ends of the stirring sheet.

### BACKGROUND

### Field of the Technology

The present disclosure relates to a developing apparatus that is used in an electrophotographic image forming apparatus.

### Description of the Related Art

Conventionally, an electrostatic capacity method is widely known as a toner remaining amount detection unit for detecting the toner remaining amount in a toner storage portion of a process cartridge or a toner cartridge. The electrostatic capacity method is one in which at least two electrodes are arranged within a toner storage portion to form a capacitor, and a change in electrostatic capacity between the capacitor electrodes is detected to thereby detect the toner remaining amount. Of the two electrodes constituting the capacitor, a first electrode receives a supply of AC voltage, and a second electrode is connected to a current detection circuit. The toner remaining amount is detected by the current detection circuit detecting a displacement current flowing through the capacitor due to the AC voltage. A configuration has been proposed (Japanese Patent Application Publication No. 2023-174061) in which a conductive sheet is fixed to a developer storage frame as a capacitor electrode in the toner storage portion.

### SUMMARY

The present disclosure is directed to advance the development of a cartridge or an electrophotographic image forming apparatus.

In order to solve the above problem, a developing apparatus according to the present disclosure includes:
a frame having a storage portion that stores developer and having insulating properties;
a first electrode portion and a second electrode portion that are inside the storage portion and exposed from the frame to an inside of the storage portion, the first electrode portion and the second electrode portion being disposed so as to face each other;
a stirring member having: a rotation shaft that rotates about a rotational axis extending in a first direction; and a sheet having a fixed end that is an end portion of the sheet in a second direction orthogonal to the first direction is fixed to the rotation shaft and a free end that is an end portion opposite to the fixed end in the second direction, a length of the sheet from the fixed end to the free end is a length capable of contacting an inner wall of the frame that forms the storage portion;
a first conductive member having the first electrode portion and a first electrical contact portion, the first electrical contact portion being connected to the first electrode portion and exposed to an outside of the storage portion; and
a second conductive member having the second electrode portion and a second electrical contact portion, the second electrical contact portion being connected to the second electrode portion and exposed to the outside of the storage portion;
wherein a part of the inner wall of the frame has a recessed portion that is recessed in a direction away from the rotation shaft in the second direction;
wherein the first electrode portion and the second electrode portion are provided in the recessed portion;
wherein a width of the recessed portion in the first direction is narrower than a width of the sheet in the first direction, and the recessed portion is positioned within a region between both ends of the sheet in the first direction; and
wherein the first conductive member and the second conductive member are integrally molded with the frame by injecting conductive resin with respect to the frame.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of a developing unit according to a first embodiment.

FIG. 2A is a cross-sectional view of a first electrode 61 and a second electrode 62 that form a detection capacitor in an embodiment of the present disclosure, and FIG. 2B is a cross-sectional view of an electric field forming electrostatic capacity generated between the first electrode 61 and the second electrode 62 in an embodiment of the present disclosure.

FIG. 3 is a cross-sectional view of an image forming apparatus main body.

FIG. 4 is a cross-sectional view of a process cartridge.

FIG. 5 is a perspective view of the process cartridge.

FIG. 6A is a perspective view of an electrode holder that holds the first electrode and the second electrode.

FIG. 6B is a perspective view with the electrode holder 69 removed from the state shown in FIG. 6A.

FIG. 7A is a perspective view showing the positional relationship between the process cartridge and a laser scanner.

FIG. 7B is a perspective view showing the positional relationship between the process cartridge and the laser scanner, viewed from an angle different from that shown in FIG. 7A.

FIG. 8A is a perspective view of a frame member when viewed from below.

FIG. 8B is a view with a cover member 93 removed from FIG. 8A.

FIG. 9A is a perspective view of a second substrate, a substrate holder, a first spring and a second spring.

FIG. 9B is a perspective view of the second substrate, the substrate holder, the first spring and the second spring, viewed from an angle different from that in FIG. 9A.

FIG. 9C is a perspective view of the second substrate, the substrate holder, the first spring and the second spring, viewed from an angle different from those of FIGS. 9A and 9B.

FIG. 10 is an explanatory view of the positional relationship among the developing unit, a first electrical contact, and a second electrical contact.

FIG. 11A is a cross-sectional view showing a situation in which a detection capacitor mold core is moved along the direction X4 relative to a detection capacitor mold cavity, in a method for forming a detection capacitor by means of conductive two-color molding (primary molding).

FIG. 11B is a cross-sectional view showing a situation in which mold clamping is performed in a state in which the detection capacitor mold core is abutted against the detection capacitor mold cavity, subsequent to the situation shown in FIG. 11A.

FIG. 11C is a cross-sectional view showing the state in which the electrode holder is formed (primary molding) by the method for forming the detection capacitor by means of conductive two-color molding (primary molding).

FIG. 12A is a cross-sectional view showing a situation in which a detection capacitor mold first core back space and a detection capacitor mold second core back space are formed by moving a detection capacitor mold first core back portion and a detection capacitor mold second core back portion along the direction X3, in a method for forming a detection capacitor by means of conductive two-color molding (secondary molding).

FIG. 12B is a cross-sectional view showing a state in which the detection capacitor composed of the first electrode and the second electrode is formed (secondary molding) in the detection capacitor mold first core back space and the detection capacitor mold second core back space, in a method for forming a detection capacitor by means of conductive two-color molding (secondary molding).

FIG. 13A is a cross-sectional view showing a situation in which the detection capacitor mold core is moved along the direction X3 after the forming of the detection capacitor, in the method for forming the detection capacitor by means of conductive two-color molding (demolding).

FIG. 13B is a cross-sectional view showing a situation in which a remaining amount detection member is demolded from the detection capacitor mold cavity and the detection capacitor mold core, and thus the conductive two-color molding is completed, in the method for forming the detection capacitor by means of conductive two-color molding (demolding).

FIG. 14A is a front view showing a configuration of the remaining amount detection member.

FIG. 14B is a cross-sectional view taken along line A-A, showing a toner sealing configuration of FIG. 14A.

FIG. 14C is a cross-sectional view taken along line B-B, showing the toner sealing configuration of FIG. 14A.

FIG. 14D is a detailed view of the toner sealing configuration shown in FIGS. 14B and 14C.

FIG. 15 is a cross-sectional view showing a configuration of the electrical contacts and a developing contact.

FIG. 16A is a perspective view showing flow passages of conductive resin branched into a first electrode gate portion and a second electrode gate portion in conductive resin molding.

FIG. 16B is a perspective view showing a first electrode flow passage and a second electrode flow passage, which are the flow passages of the conductive resin branched toward a longitudinal direction Z1 on the side facing the electrical contacts and a longitudinal direction Z2 on the side facing the detection capacitor.

FIG. 17A is a perspective view showing the flow passage of the conductive resin on the longitudinal direction Z2 side flowing beyond a first electrode toner sealing portion and a second electrode toner sealing portion into a part of the detection capacitor during conductive resin molding.

FIG. 17B is a perspective view showing the completion of molding of the detection capacitor in the conductive resin molding.

FIG. 18 is an explanatory view showing electrostatic capacity simulation results for the present embodiment and comparative embodiments.

FIG. 19A is a cross-sectional view showing a detection capacitor of Comparative Embodiment 1 in comparison with that of the present embodiment.

FIG. 19B is a cross-sectional view showing a detection capacitor of Comparative Embodiment 2 in comparison with that of the present embodiment.

FIG. 20 is a block diagram of a wiring configuration of a high-voltage circuit, a detection circuit, and the process cartridge.

FIG. 21 is an equivalent circuit diagram showing the configuration of FIG. 20 with circuit constants.

FIG. 22A is a time-series explanatory diagram showing a pulsating waveform of a toner remaining amount detection signal which changes periodically by an amplitude ΔV at time intervals of the stirring period.

FIG. 22B is a time-series explanatory diagram showing a waveform of the toner remaining amount detection signal in the case where stray capacitance in the remaining amount detection circuit becomes excessively high.

FIG. 22C is a time-series explanatory diagram showing a waveform of the toner remaining amount detection signal in the case where parasitic resistance in the remaining amount detection circuit is excessively high or the electrostatic capacity of the detection capacitor is excessively low.

### DESCRIPTION OF THE EMBODIMENTS

Hereinafter, embodiments of the present disclosure will be described in detail based on embodiments with reference to the drawings. In this regard, the dimensions, materials, shapes, relative arrangements, and the like of the components described in the embodiments may be appropriately modified according to the configurations and various conditions of apparatuses to which the present disclosure is applied. That is, the scope of the present disclosure is not intended to be limited to the embodiments described below. While a plurality of features are described in each of the embodiments, all of the plurality of features are not necessarily essential to the present disclosure and the plurality of features may be combined with each other in any way. Moreover, in the accompanying drawings, the same reference numerals are assigned to the same or similar components, and redundant descriptions thereof are omitted.

Here, a developing unit refers to a component that is attachable to and detachable from an electrophotographic image forming apparatus main body (hereinafter referred to as an “apparatus main body”) and includes at least one of toner, a toner storage portion, a developer bearing member, and a process unit acting on the developer bearing member. Representative examples of the developing unit include a developing cartridge, a process cartridge, and a toner cartridge. The developing cartridge refers to a component in which a developer bearing member and a process unit acting on the developer bearing member are configured as a cartridge, and which is detachably mounted on the apparatus main body. The process cartridge refers to a component in which an image bearing member and a process unit acting on the image bearing member are configured as a cartridge, and which is detachably mounted on the apparatus main body. The toner cartridge refers to a component that stores developer (hereinafter referred to as “toner”) to be supplied to a developing member such as a developer bearing member and is detachably mounted on the apparatus main body. Furthermore, an electrophotographic image forming apparatus refers to an apparatus that forms an image on a recording medium using an electrophotographic image forming method. Examples of an electrophotographic image forming apparatus include, for example, an electrophotographic copying machine, an electrophotographic printer (such as an LED printer, a laser beam printer, etc.), a facsimile apparatus, and a word processor.

### Embodiment 1

### Overview of Entire Image Forming Apparatus Main Body

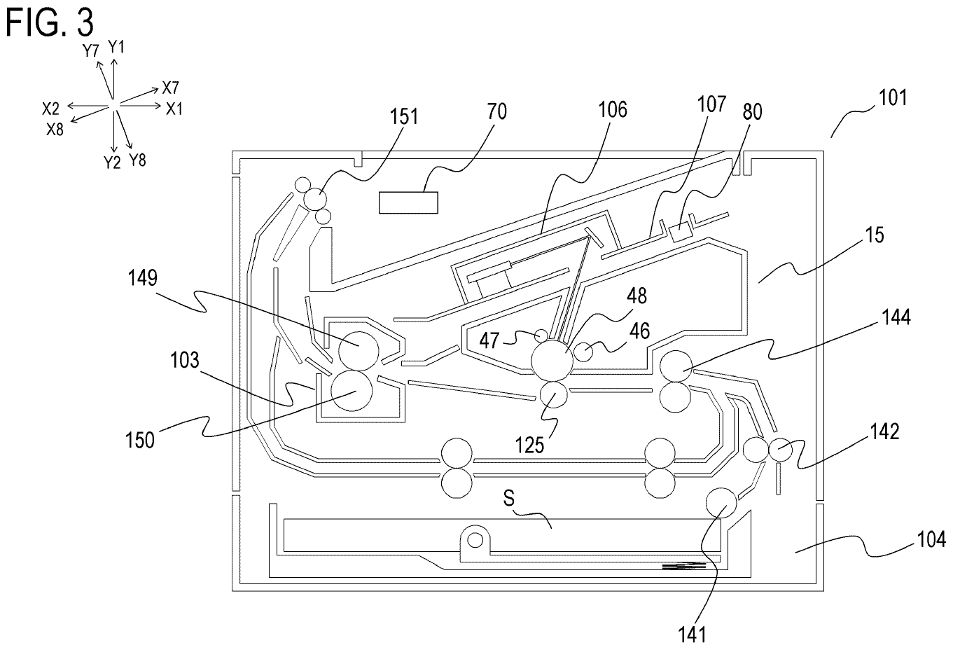

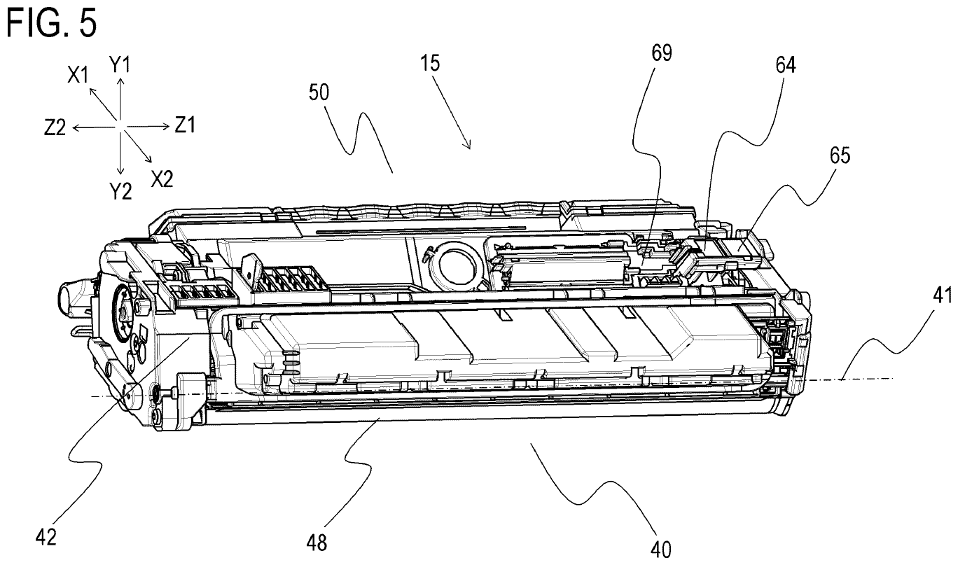

FIG. 3 is a cross-sectional view showing a schematic configuration of a monochrome laser printer which is an example of an image forming apparatus. The image forming apparatus main body (hereinafter referred to as apparatus main body 101) shown in FIG. 3 mainly includes a sheet feeding portion, an image forming portion that forms an image on a sheet, a fixing portion, a sheet discharging/reversing portion, and a duplex conveying portion. Here, in the image forming posture of the apparatus main body 101, the horizontal directions are defined as X1, X2, and the vertical directions are defined as Y1, Y2. In addition, as shown in FIG. 5, the longitudinal directions, which are perpendicular to the horizontal directions (denoted by X1, X2) and the vertical directions (denoted by Y1, Y2) are defined as Z1, Z2. The apparatus main body 101 is provided with a process cartridge 15 that is attachable to and detachable from the apparatus main body 101. The process cartridge 15 is a process unit for forming a toner image on a sheet S using an electrophotographic process, and is provided with process units such as a photosensitive drum 48 serving as an image bearing member, a charging roller 47, and a developing roller 46 serving as a developer bearing member. Here, the mounting directions of the process cartridge 15 relative to the apparatus main body 101 are defined as X7, X8, and the mounting vertical directions are defined as Y7, Y8.

A laser scanner 106 is disposed above the process cartridge 15 and exposes the photosensitive drum 48 in response to an image signal. The photosensitive drum 48 is charged to a predetermined negative polarity potential by the charging roller 47. Subsequently, the laser scanner 106 scans the surface of the photosensitive drum 48 with a laser beam, thereby forming an electrostatic latent image on the photosensitive drum 48. Thereafter, toner is supplied from the developing roller 46 onto the surface of the photosensitive drum 48, and developed and visualized as a toner image.

The sheet feeding portion includes a sheet feeding roller 141 mounted on the apparatus main body 101, and a sheet feeding cassette 104 that is attachable to and detachable from the apparatus main body 101. Sheets S stored in the sheet feeding cassette 104 are separated and fed one by one by the sheet feeding roller 141. The fed sheet S is conveyed to a registration roller pair 144 by a feed and convey roller pair 142, and then the sheet S is subjected to skew correction by the registration roller pair 144 and is conveyed to a transfer portion.

The transfer portion is configured such that a positive bias is applied to a transfer roller 125 by using a bias applying unit (not shown). As a result, the toner image on the photosensitive drum 48 is transferred onto the sheet S conveyed to the transfer portion.

The sheet S having the toner image transferred thereon is conveyed to a fixing apparatus 103, which is disposed on the downstream side in the conveyance direction as viewed from the transfer portion. The fixing apparatus 103 fixes the toner image transferred onto the sheet S, and includes a heating unit 149 provided with a heater, which is a heating portion (not shown), and a pressure roller 150, which is a pressure member that is in pressure contact with the heating unit 149 and rotates. The sheet S having the toner image formed thereon is nipped and conveyed in a nip portion formed by the heating unit 149 and the pressure roller 150, and the toner image is fixed onto the surface of the sheet S by application of heat and pressure.

The sheet S having the toner image fixed thereon is discharged out of the apparatus by a discharge roller pair 151.

### Entire Process Cartridge

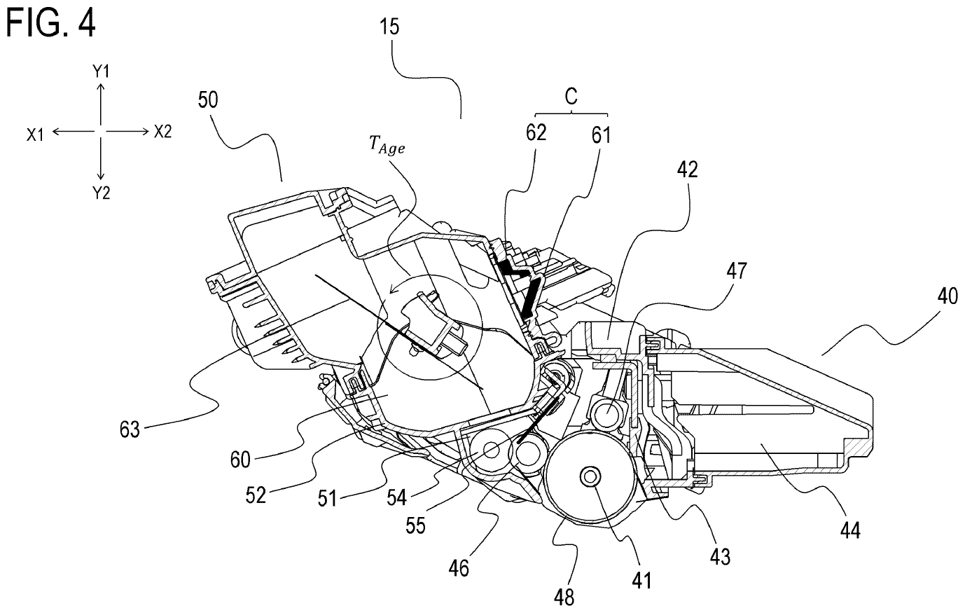

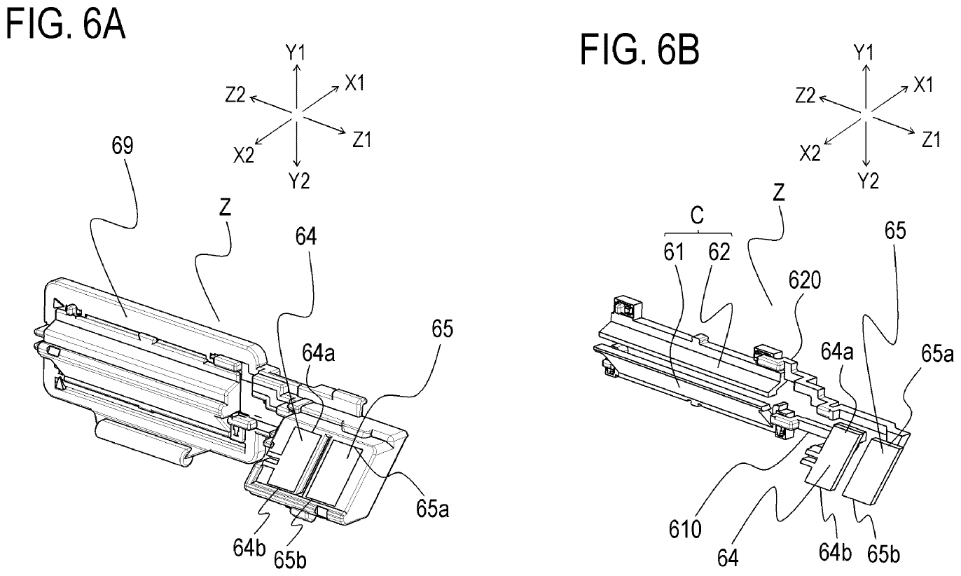

An entire configuration of the process cartridge 15 will be described with reference to FIGS. 4 to 6B. FIG. 4 is a cross-sectional view of the process cartridge 15. FIG. 5 is a perspective view of the process cartridge 15. FIG. 6A is a perspective view of an electrode holder 69 that holds a first electrode 61 and a second electrode 62. FIG. 6B is a perspective view with the electrode holder 69 removed from the state shown in FIG. 6A.

The process cartridge 15 includes a cleaning unit 40 equipped with the photosensitive drum 48 and a developing unit 50 equipped with the developing roller 46, and is attachable to and detachable from the apparatus main body 101.

The cleaning unit 40 includes the photosensitive drum 48, a drum support member 42 that rotatably supports the photosensitive drum 48 about a rotation shaft 41, a cleaning blade 43, and a waste toner storage portion 44. The photosensitive drum 48 is rotatably supported about the rotation shaft 41 by the drum support member 42. The charging roller 47 is disposed so as to be in contact with the outer peripheral surface of the photosensitive drum 48, and charges the photosensitive drum 48 by the application of a voltage from the apparatus main body 101. Further, the charging roller 47 is driven to rotate following the photosensitive drum 48. The cleaning blade 43 removes the transfer residual toner (hereinafter referred to as waste toner) remaining on the photosensitive drum 48 after the sheet S has passed between the photosensitive drum 48 and the transfer roller 125, by having its tip in elastic contact with the photosensitive drum 48. The removed waste toner is stored in the waste toner storage portion 44.

The developing unit 50 includes a developing chamber 51 in which the developing roller 46, a supply roller 54, and a developing blade 55 are disposed, and a toner storage portion 60 that supplies toner to the developing chamber 51. The developing roller 46 supplies toner to a developing region of the photosensitive drum 48. The developing roller 46 then develops an electrostatic latent image formed on the photosensitive drum 48 using toner (developer). The developing blade 55 abuts against the developing roller 46 to regulate the amount of toner adhering to the peripheral surface of the developing roller 46, and at the same time imparts a triboelectric charge to the toner. The supply roller 54 rubs against the developing roller 46 to supply the toner in the developing chamber 51 to the developing roller 46, while scraping off the excess toner adhering to the developing roller 46. The developing blade 55 abuts against the peripheral surface of the developing roller 46 to regulate the amount of toner adhering to the peripheral surface of the developing roller 46. In addition, the developing blade 55 imparts a triboelectric charge to the toner.

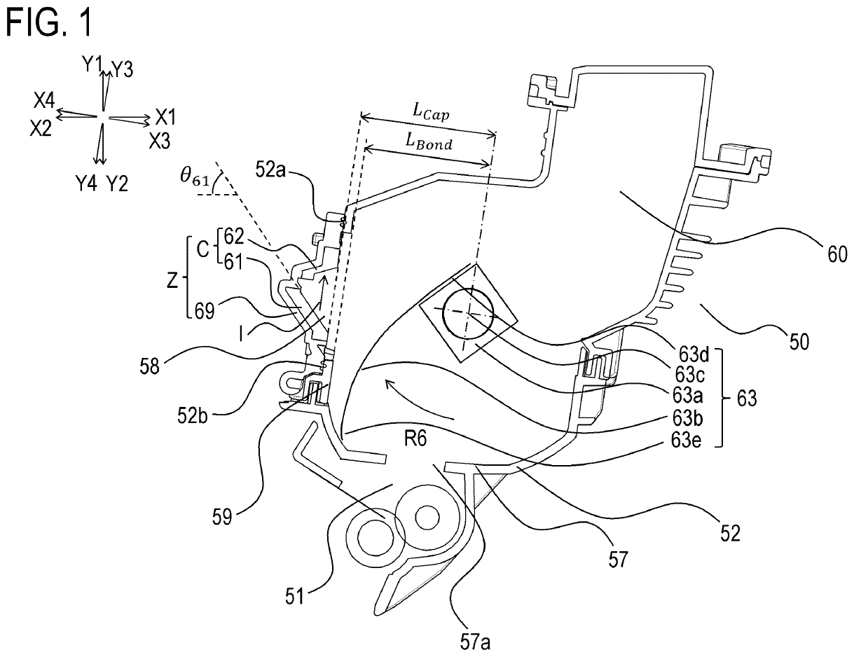

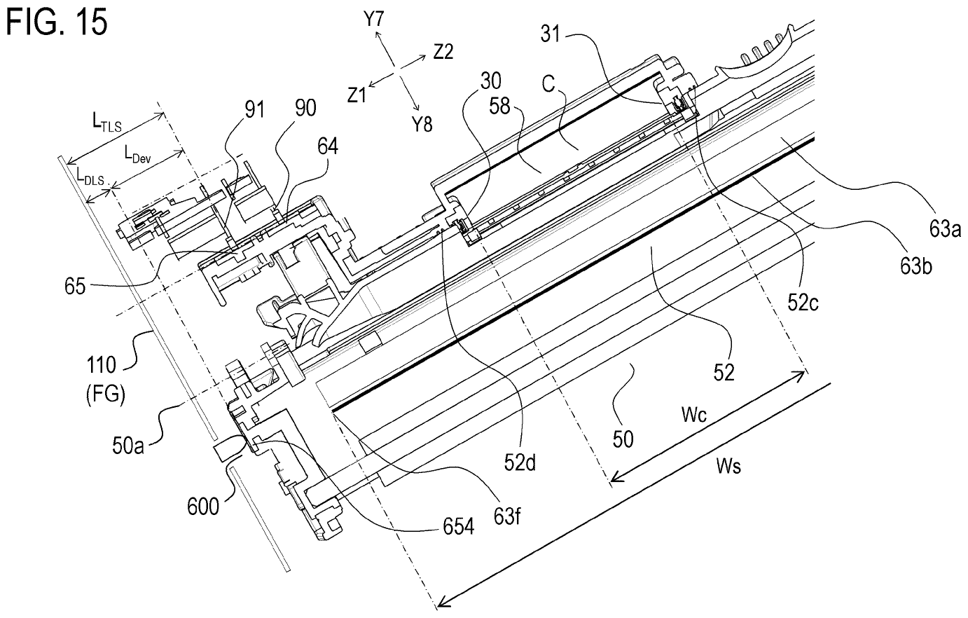

The toner stored in the toner storage portion 60 is delivered to the developing chamber 51 by the rotation of a stirring member 63 and is then supplied to the developing roller 46. Further, the toner storage portion 60 is provided with a detection capacitor C that forms an electrostatic capacity. The frame of the developing unit 50, which forms the toner storage portion 60, is provided with a first electrode 61 serving as a first electrode portion and a second electrode 62 serving as a second electrode portion—both used for detecting the electrostatic capacity inside the toner storage portion 60—such that they are respectively exposed to the interior of the toner storage portion 60. The first electrode 61 and the second electrode 62 are provided so as to face each other with a space therebetween inside the toner storage portion 60. More specifically, the inner wall of a developing frame 52, which forms the toner storage portion 60, includes a first wall surface 57 provided with an opening 57a that allows the toner storage portion 60 to communicate with the developing chamber 51, and a second wall surface 59 that is contiguous with the first wall surface 57 on a downstream side in the rotation direction of the stirring member 63 (see FIG. 1). The second wall surface 59, which serves as a part of the inner wall of the developing frame 52, is provided with a recessed portion 58 that is recessed in a direction away from the rotation shaft (the stirring shaft 63a described later) of the stirring member 63 in the direction (second direction) orthogonal to the longitudinal directions Z1, Z2 (the rotational axis of the stirring member 63) (see FIG. 1). The first electrode 61 and the second electrode 62 are provided in such a recessed portion 58. The width of the recessed portion 58 in the longitudinal directions Z1, Z2 (the first direction along the rotational axis of the stirring member 63) is defined within the recessed portion 58 by a first side wall 30 which faces the same direction and a second side wall 31 which faces the same direction and opposes the first side wall 30 in the same direction (see FIG. 15). The first electrode 61 and the second electrode 62 are each provided in such a way that the direction (the first direction) along the rotational axis of the stirring member 63 serves as the longitudinal direction, and extend in the longitudinal directions Z1, Z2 between the first side wall 30 and the second side wall 31. The first electrode 61 is positioned on the upstream side and the second electrode 62 is positioned on the downstream side, with respect to the rotation direction of the stirring member 63. The first electrode 61 is provided so as to have a shape that, when viewed in the direction of the rotational axis of the stirring member 63 (the first direction), gradually becomes farther from the rotation shaft of the stirring member 63 as it extends from the upstream side to the downstream side in the rotation direction of the stirring member 63. The second electrode 62 is provided so as to have a shape that, when viewed in the direction of the rotational axis of the stirring member 63 (the first direction), gradually becomes closer to the rotation shaft of the stirring member 63 as it extends from the upstream side to the downstream side in the rotation direction of the stirring member 63. The detection capacitor C is formed by the first electrode 61 and the second electrode 62 and is arranged substantially parallel to the longitudinal directions Z1, Z2. The rotation of the stirring member 63 causes toner to move into and out of the space between the first electrode 61 and the second electrode 62. The entry and exit of toner inside the detection capacitor C causes the electrostatic capacity between the first electrode 61 and the second electrode 62 to vary in accordance with the rotation period T_{Age} of the stirring member 63 (hereinafter referred to as the stirring period T_{Age}).

As shown in FIG. 6A, a first electrical contact 64 serving as a first electrical contact portion and a second electrical contact 65 serving as a second electrical contact portion are exposed from the electrode holder 69 for contact with a spring (not shown) on the apparatus main body side, which will be described later. As shown in FIG. 6B, the first electrode 61 and the first electrical contact 64 inside the developing unit 50 are configured to be electrically connected by being integrally molded using conductive resin. Similarly, the second electrode 62 and the second electrical contact 65 inside the developing unit 50 are configured to be electrically connected by being integrally molded using conductive resin. More specifically, the frame of the developing unit 50 is composed of an insulating part having insulating properties and a conductive part possessing conductive properties. The latter conductive part is integrally molded into the former insulating part such that it is exposed to both the inside (the toner storage portion 60) and the outside of the frame. The conductive part includes a first conductive portion (first conductive member), in which the part exposed to the toner storage portion 60 serves as the first electrode 61 and the part exposed to the outside of the frame serves as the first electrical contact 64, and a second conductive portion (second conductive member), in which the part exposed to the toner storage portion 60 serves as the second electrode 62 and the part exposed to the outside of the frame serves as the second electrical contact 65. Furthermore, the insulating part is divided into two parts: one (first part) that pivotally supports the stirring member 63 or the like, and one (second part) that is configured separately from the first part and into which the conductive part is integrally molded. The former forms the developing frame 52, while the latter forms the electrode holder 69.

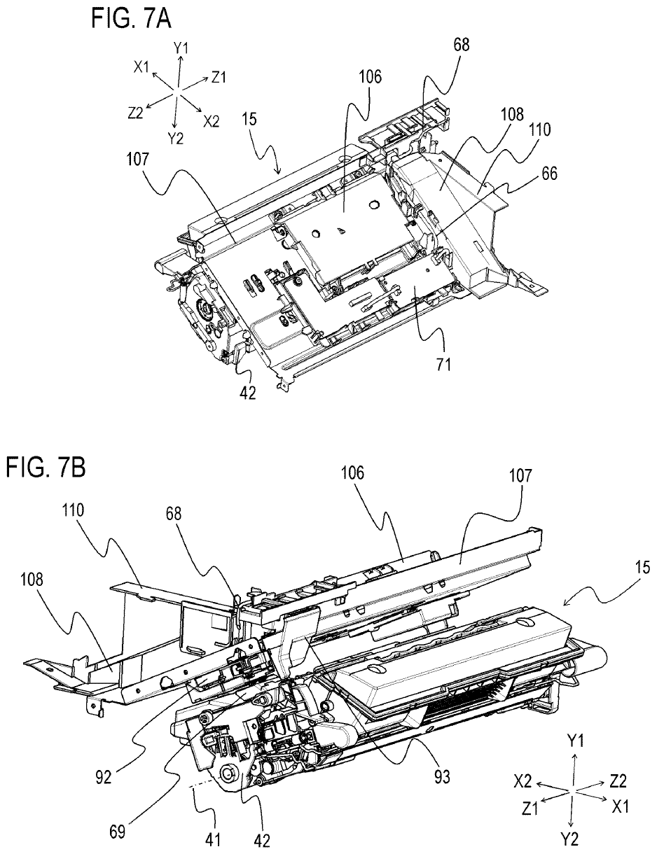

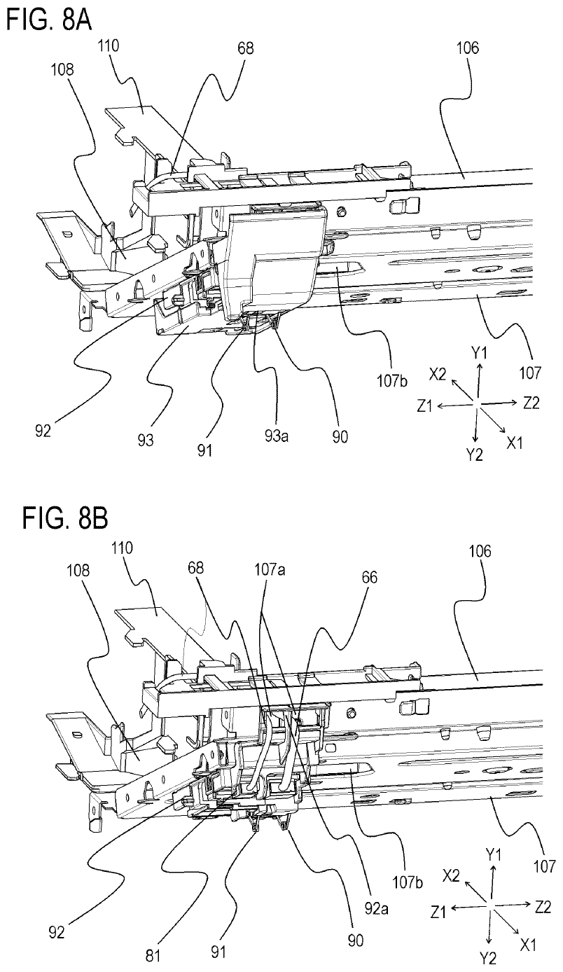

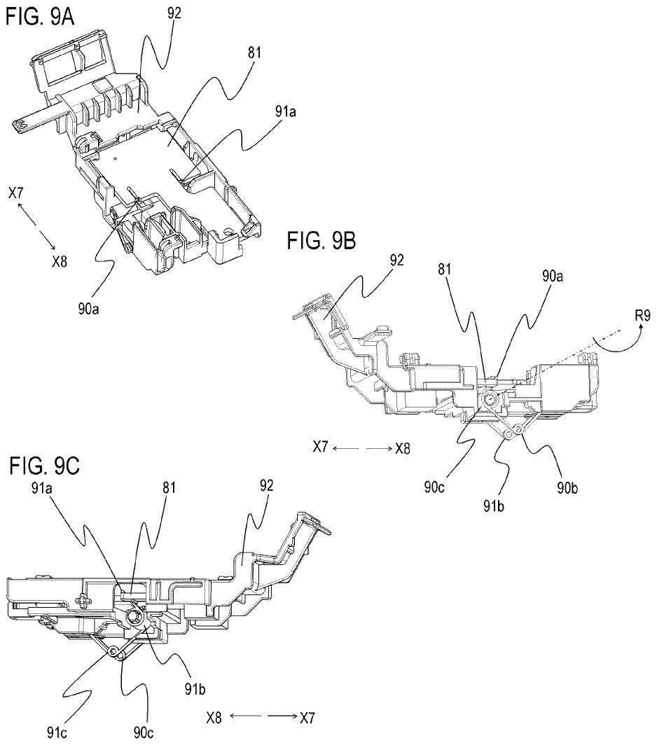

Next, the configuration of the apparatus main body 101 in the present embodiment will be described in detail with reference to FIGS. 7A to 9C. FIGS. 7A and 7B are perspective views showing the positional relationship between the process cartridge 15 and the laser scanner 106. FIG. 8A is a perspective view of a frame member 107 as viewed from below, and FIG. 8B is a view with a cover member 93 removed from FIG. 8A. FIGS. 9A to 9C are perspective views of a second substrate 81, a substrate holder 92, a first spring 90, and a second spring 91.

As shown in FIGS. 7A and 7B, the laser scanner 106, which is disposed above the process cartridge 15 in the direction of gravity, is fixed to a metallic frame member 107 arranged between the laser scanner 106 and the process cartridge 15. By virtue of this fixation to the metallic frame member 107, the process cartridge 15 and the laser scanner 106 can be arranged with high rigidity and high precision. A first substrate 71, which includes an AC voltage output circuit, is fixed above the frame member 107. In addition, the second substrate 81 (see FIG. 8B), which includes a current detection circuit, is disposed below the frame member 107 and held by a substrate holder 92. The first substrate 71 and the second substrate 81 are electrically connected via a cable (AC voltage line) 66. The second substrate 81 will be described later. A duct 108 for cooling the photosensitive drum 48 is provided on the frame member 107. The cable (AC voltage line) 66 is routed along the duct 108 and, as shown in FIG. 8B, connected to the second substrate 81 through a hole 107a provided in the frame member 107. The second substrate 81 and an engine controller (not shown) are connected via a cable (signal line) 68, which, like the cable (AC voltage line) 66, is routed through the hole 107a in the frame member.

As shown in FIG. 8B and FIGS. 9A to 9C, the substrate holder 92 also holds the first spring 90 and the second spring 91 (hereinafter referred to as electrical contact springs). The electrical contact springs 90, 91 are torsion springs, with their fixed-end sides 90a, 91a in contact with the second substrate 81. The free-end sides 90b, 91b of the electrical contact springs 90, 91 press against the first electrical contact 64 and the second electrical contact 65, which are provided on the developing unit 50, with a predetermined contact force. The coil portions 90c and 91c of the torsion springs are positioned upstream, relative to the insertion direction of the process cartridge 15, of contact portions 90b, 91b where the free-end sides engage with the first electrical contact 64 and the second electrical contact 65. The coil portions 90c and 91c are configured to rotate in the torsion spring rotationc direction R9 shown in FIG. 9B, in response to the insertion of the process cartridge 15. As shown in FIG. 8A, the substrate holder 92, the first spring 90 and the second spring 91 are covered by the cover member 93. The contact portions 90b, 91b on the free-end sides of the first and second springs 90, 91 are configured to be exposed through holes 93a provided in the cover member 93. The contact portions 90b, 91b have a shape formed by being wound into a single-turn coil.

### Toner Remaining Amount Detection Circuit

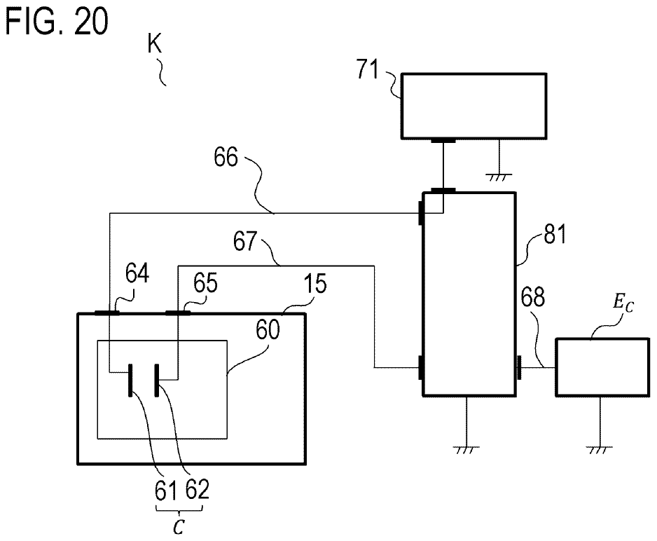

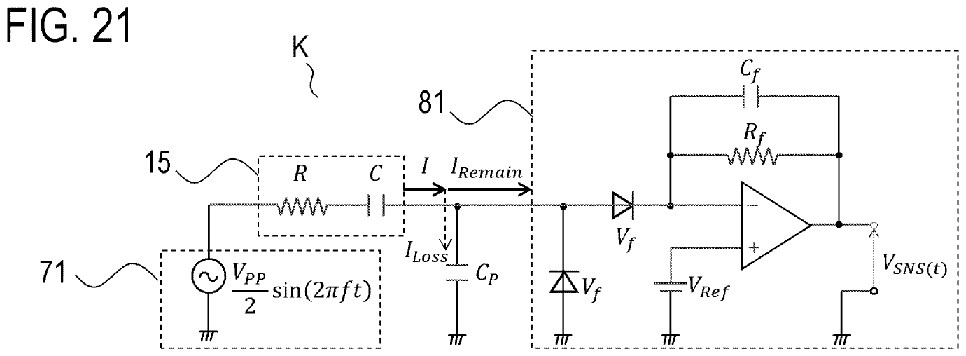

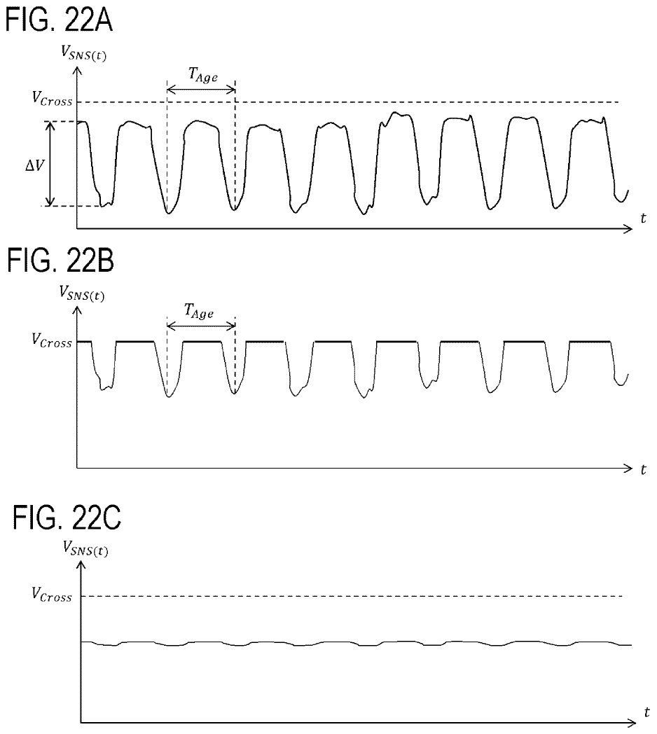

Regarding the configuration of the toner remaining amount detection circuit K (hereinafter referred to as the remaining amount detection circuit K) and the toner remaining amount detection signal V_{(SNS(t))} (hereinafter referred to as the remaining amount detection signal V_{(SNS(t))}) obtained from the remaining amount detection circuit K in the embodiment of the present disclosure, an explanation will be given with reference to FIGS. 9A to 9C, FIG. 20, FIG. 21, and FIGS. 22A to 22C. FIG. 20 is a block diagram showing the wiring configuration between the first substrate 71, the second substrate 81, and the process cartridge 15 in the remaining amount detection circuit K. FIG. 21 is an equivalent circuit diagram in which the elements of the remaining amount detection circuit K are expressed by electrical circuit constants. FIGS. 22A to 22C are time-series diagrams showing the remaining amount detection signal V_{(SNS(t))} obtained from the remaining amount detection circuit K.

As shown in FIG. 20, the remaining amount detection circuit K is composed of the first substrate 71 (AC voltage output circuit), the process cartridge 15, and the second substrate 81 (current detection circuit). The first substrate 71 is electrically connected to the first electrode 61, which is one end of the detection capacitor C provided in the process cartridge 15, via the cable (AC voltage line) 66 and the first electrical contact 64. The second electrode 62, which is the other end of the detection capacitor C, is electrically connected to the second substrate 81 via the second electrical contact 65 and the remaining amount detection signal line 67. The second substrate 81 is electrically connected to an engine controller E_{C} via the cable (signal line) 68.

As shown in FIG. 21, the first substrate 71 is an AC voltage output circuit having an AC power supply, and applies an AC voltage of (V_{PP}/2) sin (2πft) to the process cartridge 15. Here, V_{PP} denotes the amplitude of the AC voltage, f denotes the frequency of the AC voltage, π denotes the mathematical constant pi, and t denotes the elapsed time. The second substrate 81 is composed of a half-wave rectification portion consisting of two half-wave rectifier diodes V_{f} and a first-order low-pass filter. The first-order low-pass filter is composed of an operational amplifier driven by a reference voltage V_{Ref}, a detection sensitivity resistor Rf for current-to-voltage conversion, and a cutoff capacitor C_{f} for noise suppression.

The AC voltage input to the process cartridge 15 is output as a displacement current I to the second substrate 81 side via the parasitic resistance R existing between the electrical contact springs 90, 91 shown in FIGS. 9A to 9C and the electrical contacts 64, 65 shown in FIG. 20, as well as the detection capacitor C. Since the displacement current I is affected by the stray capacitance CP generated between the frame GND and the wiring of other circuits, part of the displacement current I leaks out of the remaining amount detection circuit K as a displacement current loss component I_{Loss}. As a result, the effective displacement current component I_{Remain}, which is the residual between the displacement current I and the displacement current loss component I_{Loss}, is input to the second substrate 81. The effective displacement current component I_{Remain} input to the second substrate 81 is half-wave rectified via the half-wave rectification portion, and is then output as the remaining amount detection signal V_{(SNS(t))} through the current-to-voltage conversion function of the first-order low-pass filter. When Ohm's law and Kirchhoff's laws are applied to the equivalent circuit shown in FIG. 21 to solve for the remaining amount detection signal V_{(SNS(t))}, the following equation can be obtained.

$${V}_{SNS ( t )} = {V}_{Ref} - {R}_{f} \{ \frac{\frac{1}{2} ( \frac{{V}_{PP}}{π} - {V}_{f} )}{R + \frac{1}{2 π fC}} - π {fV}_{f} {C}_{P} \}$$

As previously described, the electrostatic capacity of the detection capacitor C changes periodically at time intervals of the stirring period T_{Age} due to the entry and exit of toner into and out of the detection capacitor C. Therefore, as shown in FIG. 22A, the remaining amount detection signal V_{(SNS(t))} has a pulsating waveform which changes periodically by the amplitude ΔV at time intervals of the stirring period T_{Age}. This remaining amount detection signal V_{(SNS(t))} is subjected to digital signal processing by the engine controller EC to calculate an amplitude ΔV and the duty cycle. The correlation between the amplitudes ΔV and the duty cycle and the toner remaining amount in the process cartridge 15 is acquired in advance according to the configuration of the process cartridge 15, and the correlation is compared with the amplitudes ΔV and the duty cycle calculated during product use, thereby estimating the toner remaining amount.

From the above equation, if the stray capacitance Cp in the remaining amount detection circuit K becomes excessively high, as shown in FIG. 22B, the remaining amount detection signal V_{(SNS(t))} will exceed the allowable detection voltage V_{Cross}, resulting in clipping of the remaining amount detection signal V_{(SNS(t))} and thereby making accurate toner remaining amount detection impossible. Therefore, to reduce the stray capacitance CP, sufficient gaps are provided between the wiring from the detection capacitor C to the second substrate 81, namely, the conduction path from the second electrode 62 to the second electrical contact 65 and the remaining amount detection signal line 67, and the frame GND as well as the wiring of other circuits. Furthermore, as can be seen from the above equation, if the parasitic resistance R in the remaining amount detection circuit K is excessively high or the electrostatic capacity of the detection capacitor C is excessively low, the amplitude ΔV of the remaining amount detection signal V_{(SNS(t))} cannot be obtained sufficiently, as shown in FIG. 22C, making accurate toner remaining amount detection impossible. Therefore, the electrostatic capacity of the detection capacitor C is sufficiently ensured while suppressing the parasitic resistance R generated between the conduction path from the first electrical contact 64 to the first electrode 61 and the conduction path from the second electrode 62 to the second electrical contact 65.

### Arrangement Configuration of Electrical Contacts

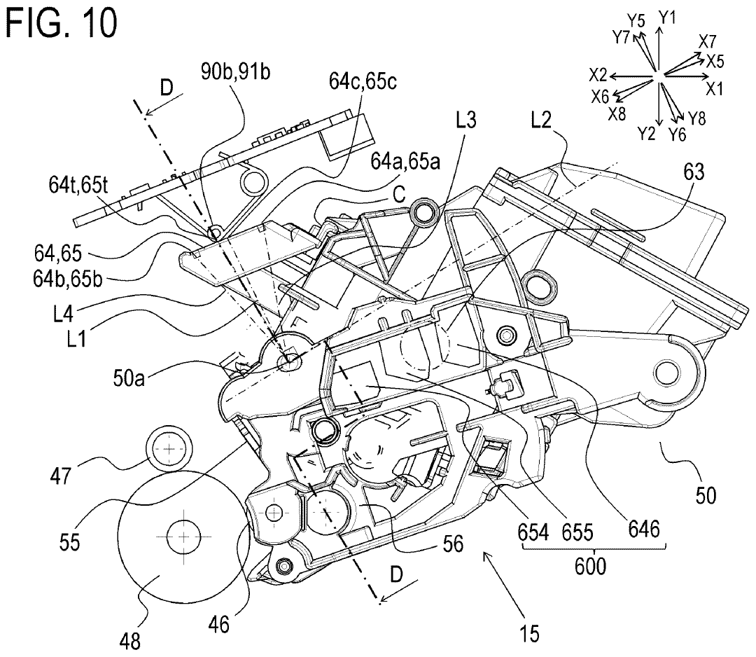

The arrangement configuration of the electrical contacts 64, 65 will be described with reference to FIGS. 6A, 6B, and 10. FIG. 10 is a side view showing the positional relationship between the developing unit 50 and the electrical contacts 64, 65. As shown in FIG. 10, the developing unit 50 is provided with developing contact 600 for supplying a predetermined bias to the developing roller 46, supply roller 54 and developing blade 55, respectively. The developing contact 600 is composed of a developing roller contact 646 that supplies bias to the developing roller 46, a supply roller contact 654 that supplies bias to the supply roller 54, and a developing blade contact 655 that supplies bias to the developing blade 55. The developing unit 50 is pivotally supported so as to be swingable about the swing center 50a of the developing unit provided in the process cartridge 15. This allows the developing unit 50, in a state in which the process cartridge is mounted on the apparatus main body 101 shown in FIG. 3, to assume a contact state in which the developing roller 46 abuts the photosensitive drum 48 and a separated state in which the developing roller 46 is spaced apart from the photosensitive drum 48. The switching between the contact state and the separated state is performed by the developing unit 50 rotating about the swing center 50a upon receiving pressing force from a developing separation mechanism (not shown) provided in the apparatus main body 101. On the other hand, the rotational axis centers of the photosensitive drum 48 and the charging roller 47 are fixed in a state in which they are mounted on the apparatus main body 101. During image forming operation, toner development onto the photosensitive drum 48 is performed in the contact state. After image forming operation is completed (during non-use), switching to the separated state releases the contact pressure of the developing roller 46 against the photosensitive drum 48, thereby enabling an extended service life of the developing roller 46.

The electrical contacts 64, 65 contact the free-end sides 90b and 91b of the electrical contact springs 90, 91 at a first electrical contact abutment portion 64t and a second electrical contact abutment portion 65t (hereinafter referred to as electrical contact abutment portions), respectively. The electrical contacts 64, 65 are formed as surfaces connecting a first electrical contact first end portion 64a and a second electrical contact first end portion 65a (hereinafter referred to as electrical contact first end portions) and a first electrical contact second end portion 64b and a second electrical contact second end portion 65b (hereinafter referred to as electrical contact second end portions). Here, the midpoints of the electrical contact first end portions 64a and 65a and the electrical contact second end portions 64b and 65b are defined as a first electrical contact center portion 64c and a second electrical contact center portion 65c (hereinafter referred to as electrical contact center portions), respectively.

Additionally, a line connecting the electrical contact center portions 64c and 65c and the swing center 50a is defined as a first line L1, and a line perpendicular to the first line L1 and passing through the swing center 50a is defined as a second line L2, respectively.

Next, the axial directions passing through the electrical contact first end portions 64a and 65a and the electrical contact second end portions 64b and 65b are defined as electrical contact parallel directions X5 and X6, and the axial directions perpendicular to the electrical contact parallel directions X5 and X6 are defined as electrical contact vertical directions Y5 and Y6. Furthermore, a line passing through the electrical contact first end portions 64a and 65a and the swing center 50a is defined as a third line L3, and a line passing through the electrical contact second end portions 64b and 65b and the swing center 50a is defined as a fourth line L4, respectively.

In the present embodiment, the angle formed between the electrical contact parallel directions X5 and X6 and the mounting directions X7 and X8 of the process cartridge 15 is set to 15 degrees or less. It should be noted that, from the perspectives of downsizing the apparatus main body 101 and suppressing contact wear caused by fluctuations in electrical contact pressure when the process cartridge 15 is mounted, the aforementioned angle is minimized as much as possible. Moreover, the electrical contact abutment portions 64t and 65t are arranged as close as possible to the electrical contact center portions 64c and 65c. This is from the perspective of ensuring the engagement margin between the electrical contacts 64, 65 and the free-end sides 90b, 91b of the electrical contact springs 90, 91, taking into account component tolerances and creep deformation due to long-term storage.

In the present embodiment, the first line L1 is configured such that L1≤L3 and L1≤L4 with respect to the third line L3 and the fourth line L4.

Therefore, when the inclination of the contact surfaces of the electrical contacts 64, 65 satisfies either L3<L1<L4 or L3>L1>L4, wear of the electrical contacts 64, 65 caused by fluctuations in contact pressure during switching between the contact state and the separated state of the developing unit 50 is suppressed, enabling an extended product service life. Additionally, since the increase in contact resistance caused by wear of the electrical contacts 64, 65 can be suppressed, a rise in parasitic resistance, which is a factor in the attenuation of the remaining amount detection signal V_{(SNS(t))}, can be prevented. As a result, stabilization of the remaining amount detection signal V_{(SNS(t))} throughout the product service life ensures the accuracy of toner remaining amount detection.

In the present embodiment, the contact surfaces of the electrical contacts 64, 65 are formed in a planar shape satisfying L1<L3 and L1<L4; alternatively, they may be formed in an arc shape centered on the swing center 50a and satisfying L1=L3 and L1=L4.

The contact surfaces of the electrical contacts 64, 65 are formed into a planar shape from the perspectives of cost reduction through shape simplification and ease of inspection.

### Arrangement Configuration of Electrical Contacts and Developing Contacts

The developing roller 46 and the supply roller 54 are rotatably supported by a developing bearing 56 provided in the developing unit 50. Inside the developing bearing 56, the developing contact 600 and the respective power supply passages from the developing contact 600 to the developing roller 46, the supply roller 54, and the developing blade 55 are each provided by means of two-color molding of conductive resin. The developing contact 600, namely the developing roller contact 646, the supply roller contact 654, and the developing blade contact 655, is electrically connected to the developing roller 46, the supply roller 54, and the developing blade 55 via their respective power supply passages. The developing contact 600 may be formed by means of two-color molding of conductive resin integrally with the respective power supply passages, or it may be provided as a separate component from the respective power supply passages using sheet metal.

In the present embodiment, the electrical contacts 64, 65 are disposed opposite the developing contact 600, the developing roller 46, the supply roller 54, and the developing blade 55, with the second line L2 serving as the boundary between them. Furthermore, when the process cartridge 15 is in the image forming posture, the electrical contacts 64, 65 are disposed on the upper side in the vertical direction Y1 relative to the developing contact 600. In addition, the normal direction of the electrical contacts 64, 65 is provided to face the electrical contact vertical direction Y5, and the vertical direction component of the electrical contact vertical direction Y5 coincides with the vertical direction Y1.

In the present embodiment, as shown in FIGS. 10 and 20, the remaining amount detection circuit K composed of the electrical contacts 64, 65 and the detection capacitor C is arranged in the first phase, while the developing circuit composed of the developing contact 600, the developing roller 46, the supply roller 54, and the developing blade 55 is arranged separately in the second phase. Therefore, clipping of the remaining amount detection signal V_{(SNS(t))} caused by the stray capacitance CP between the remaining amount detection circuit and the developing circuit can be prevented, and it becomes possible to accurately perform toner remaining amount detection using an electrostatic capacity method. From the perspective of suppressing stray capacitance CP, the electrical contacts 64, 65 are disposed as far apart as possible from the developing contact 600, and a wiring distance of 5 mm or more is ensured between the wirings of the overall power supply passages of the remaining amount detection circuit K and the developing circuit. Furthermore, the normal of the developing contact 600 in the present embodiment is oriented in the longitudinal direction Z1, that is, it is disposed outward in the longitudinal direction relative to the process cartridge 15. In contrast, the electrical contacts 64, 65 are provided on the upper side in the vertical direction Y1 relative to the developing contact 600, while the vertical direction component of the electrical contact vertical direction Y5, which is the normal direction of the electrical contacts 64, 65, coincides with the vertical direction Y1. Therefore, in the architectural space on the horizontal direction X1-vertical direction Y1 coordinate system, which is an arbitrary cross-section of the process cartridge 15, the electrical contacts 64, 65 and the developing contact 600 are separately disposed with different normal directions. This enables the electrical contacts 64, 65 and the developing contact 600 to each secure sufficient arrangement space while taking into account component tolerances. As a result, during mounting onto the apparatus main body 101, the electrical contacts 64, 65 and the developing contact 600 are able to establish stable electrical connections without interfering with each other. In addition, the normals of the electrical contacts 64, 65 and the developing contact 600 are each oriented in a direction different from the vertical direction Y2, which is the downward direction of gravity. For example, there may be cases where the process cartridge 15 is removed from the apparatus main body 101 and placed on another place such as a desk or a workbench, for reasons such as jam clearance during operation of the apparatus main body 101. Even in such cases, it is possible to suppress the risk of damage such as dents or scratches to the electrical contacts 64, 65 and the developing contact 600.

Next, the arrangement configuration of the electrical contacts 64, 65 and the developing contact 600 in the longitudinal directions Z1, Z2 will be described with reference to FIG. 15. FIG. 15 is a cross-sectional view taken along line D-D of the electrical contacts 64, 65 and the developing contact 600 in FIG. 10. As shown in FIG. 15, the supply roller contact 654, which is part of the developing contact 600, is provided at the end portion of the developing unit 50 on the longitudinal direction Z1 side. The other developing contacts, namely the developing roller contact 646 and the developing blade contact 655, also share the same longitudinal arrangement as the supply roller contact 654. The second electrical contact 65 and the second spring 91 are disposed opposite the developing contact 600 at a longitudinal distance L_{Dev} between the electrical contact and the developing contact in the longitudinal directions Z1, Z2. In addition, the second electrical contact 65 and the second spring 91 are disposed opposite a left side plate 110, which serves as a frame ground FG, at a longitudinal distance L_{TLS} between the electrical contact and the left side plate. The developing contact 600 is disposed opposite the left side plate 110 at a longitudinal distance LDLS between the developing contact and the left side plate, which is the difference between the longitudinal distance L_{TLS} (longitudinal distance between the electrical contact and the left side plate) and the longitudinal distance L_{Dev} (longitudinal distance between the electrical contact and the developing contact).

The longitudinal distance L_{TLS} between the electrical contact and the left side plate and the longitudinal distance L_{Dev} between the electrical contact and the developing contact are set to be longer than the longitudinal distance LDLS between the developing contact and the left side plate. Accordingly, from the perspective of the longitudinal directions Z1, Z2 as well, clipping of the remaining amount detection signal V_{(SNS(t))} caused by the stray capacitance CP between the remaining amount detection circuit K and the developing circuit, and between the remaining amount detection circuit K and the left side plate 110, can be prevented.

Therefore, it becomes possible to accurately perform toner remaining amount detection using an electrostatic capacity method.

### Manufacturing Method for Remaining Amount Detection Member Z

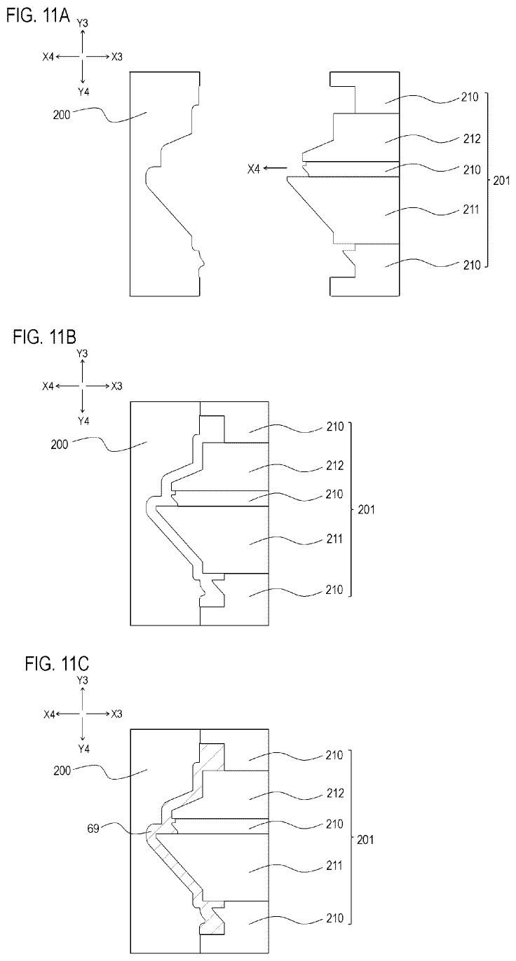

A manufacturing method for a remaining amount detection member Z composed of the detection capacitor C and the electrode holder 69 will be described with reference to FIG. 1 and FIGS. 11A to 13B. FIG. 1 is a cross-sectional view showing the configuration of the developing unit 50 and the detection capacitor C. FIGS. 11A to 13B are cross-sectional views showing a forming method for the remaining amount detection member Z by means of conductive two-color molding.

FIGS. 11A to 13B, the detection capacitor C is injection-molded by a detection capacitor mold cavity 200, which is a fixed-side mold, and a detection capacitor mold core 201, which is a movable-side mold. The detection capacitor mold core 201 is composed of a detection capacitor mold core base portion 210, a detection capacitor mold first core back portion 211, and a detection capacitor mold second core back portion 212. The detection capacitor mold first core back portion 211 and the detection capacitor mold second core back portion 212 are configured to be translatable along the detection capacitor closest vertical directions X3, X4, which are the mold clamping directions, relative to the detection capacitor mold core base portion 210.

First, as shown in FIG. 11A, the detection capacitor mold core 201 is moved along the detection capacitor closest vertical direction X4 relative to the detection capacitor mold cavity 200, and then abutted against the detection capacitor mold cavity 200 as shown in FIG. 11B. Mold clamping is performed in this state, and when the insulating resin, which is the first molding material, is molded in the mold, the electrode holder 69 is formed (primary molding), as shown in FIG. 11C.

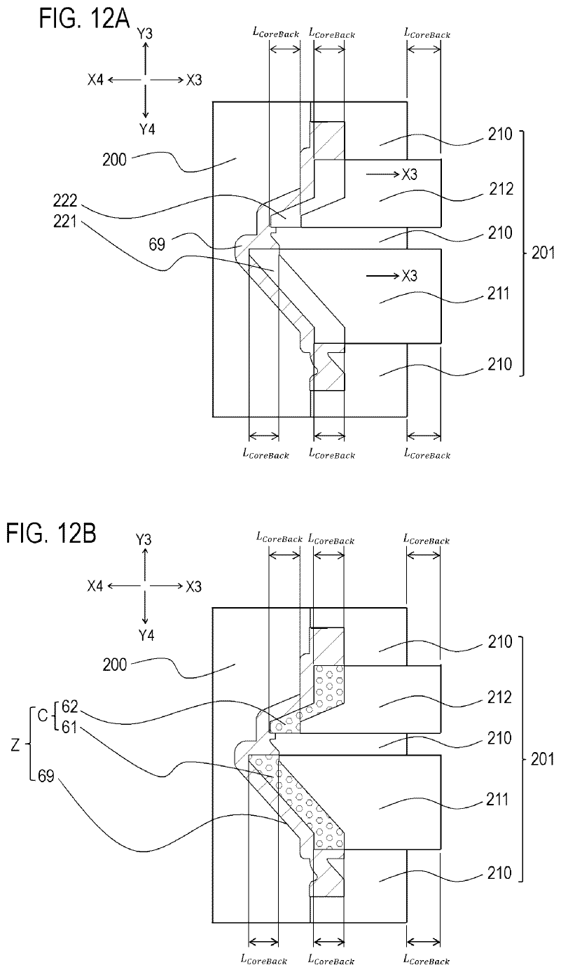

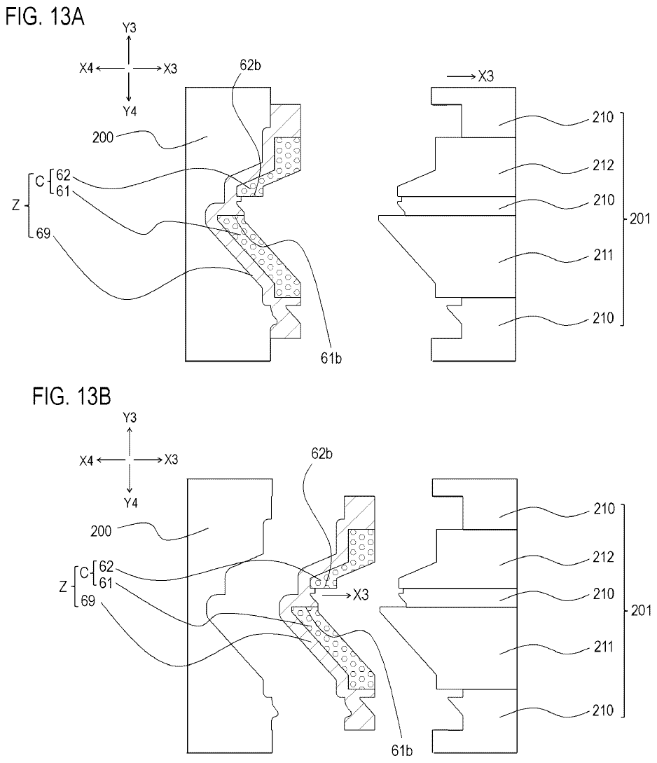

After the electrode holder 69 is formed, as shown in FIG. 12A, the detection capacitor mold first core back portion 211 and the detection capacitor mold second core back portion 212 are moved by a core back distance of L_{Coreback} along the detection capacitor closest vertical direction X3. A detection capacitor mold first core back space 221 is formed in the mold as a result of the core back of the detection capacitor mold first core back portion 211. Similarly, a detection capacitor mold second core back space 222 is formed in the mold as a result of the core back of the detection capacitor mold second core back portion 212. In this state, when the conductive resin, which is the second molding material, is molded in the mold, the detection capacitor C composed of the first electrode 61 and the second electrode 62 is formed (secondary molding), as shown in FIG. 12B. The wall thickness of the detection capacitor C in the detection capacitor closest vertical direction X4 is approximately equal to the product of the core back distance L_{Coreback} and the molding shrinkage rate of the conductive resin. That is, the respective thicknesses of the first electrode 61 and the second electrode 62 in the normal direction of the detection capacitor connection wall surfaces 52a, 52b are substantially equal. As shown in FIG. 13A, after the detection capacitor C is formed, the detection capacitor mold core 201 is moved along the detection capacitor closest vertical direction X3. Finally, as shown in FIG. 13B, the detection capacitor C moves along the detection capacitor closest vertical direction X3 relative to the detection capacitor mold cavity 200. This causes the remaining amount detection member Z to be demolded from the detection capacitor mold cavity 200 and the detection capacitor mold core 201, and thus the conductive two-color molding is completed.

As shown in FIGS. 11A to 13B, the detection capacitor C is formed by the core back of the detection capacitor mold core 201. Therefore, the first electrode tip facing surface 61b (first facing surface) and the second electrode tip facing surface 62b (second facing surface) are formed to be parallel to the detection capacitor closest vertical directions X3 and X4, which are core back directions. Through the above steps, the conductive two-color molding of the remaining amount detection member Z composed of the detection capacitor C and the electrode holder 69, is completed.

### Configuration of Remaining Amount Detection Member Z

As shown in FIGS. 1 and 15, the developing unit 50 is provided with the developing frame 52, the stirring member 63, and the remaining amount detection member Z. The stirring member 63 is composed of the stirring shaft 63a and a stirring sheet 63b, and is rotatably supported by the developing frame 52 about the rotational axis center 63c of the stirring member 63 (i.e., about the rotational axis of the stirring shaft 63a) in the stirring sheet rotation direction R6. One end of the stirring sheet is fixed to the stirring shaft 63a, and the other end, as a free end, flexes along the inner wall of the toner storage portion 60 while periodically circulating and stirring the toner at time intervals of the stirring period T_{Age}. That is, the stirring sheet 63b has one end (end portion) in a direction (second direction) orthogonal to the rotational axis (first direction) fixed to the stirring shaft 63a as a fixed end, and the other end in a direction (second direction) orthogonal to the rotational axis, i.e., the end portion opposite the fixed end, serves as a free end. The length from the fixed end to the free end is configured to be capable of contacting the inner wall (at least the first wall surface 57 and the second wall surface 59) of the developing frame 52 that forms the toner storage portion 60.

The electrode holder 69, which forms the remaining amount detection member Z, is integrally connected to the two detection capacitor connection wall surfaces 52a, 52b provided on the developing frame 52. On the other hand, the detection capacitor C shown in FIG. 15 is also integrally connected to both a detection capacitor connection first side wall 52c and a detection capacitor connection second side wall 52d at both ends in the longitudinal directions Z1, Z2. That is, the detection capacitor C is integrally connected to the developing frame 52 along a closed-curve-shaped connection surface formed by the detection capacitor connection wall surfaces 52a, 52b, the detection capacitor connection first side wall 52c, and the detection capacitor connection second side wall 52d. These connection surfaces (the detection capacitor connection wall surfaces 52a, 52b, the detection capacitor connection first side wall 52c, and the detection capacitor connection second side wall 52d) are surfaces contiguous with the outer wall of the developing frame 52 and are substantially parallel to the rotational axis of the stirring member 63.

Furthermore, the first electrode 61 forming the detection capacitor Cis arranged with an inclination of a first electrode inclination angle θ61, which is set larger than the angle of repose of toner, relative to the horizontal directions X1, X2. The closest approach directions of the first electrode 61 and the second electrode 62 (hereinafter referred to as detection capacitor closest approach directions Y3, Y4) are provided substantially parallel to the detection capacitor connection wall surfaces 52a, 52b. In other words, the detection capacitor closest vertical directions X3, X4, which are perpendicular to the detection capacitor closest approach directions Y3, Y4, are provided substantially perpendicular to the detection capacitor connection wall surfaces 52a, 52b. The distance L_{Bond} between the stirring center and the detection capacitor connection inner wall, which is the distance from the rotational axis center 63c of the stirring member 63 to the toner storage portion 60 inner wall side of the detection capacitor connection wall surfaces 52a, 52b, is set shorter than the distance L_{Cap} between the stirring center and the detection capacitor start end, which is the distance from the same rotational axis center 63c to the detection capacitor connection wall surfaces 52a, 52b. The distance L_{Bond} between the stirring center and the detection capacitor connection inner wall is the distance from the rotational axis center 63c to the region of the inner wall of the developing frame 52 corresponding to the detection capacitor connection wall surfaces 52a, 52b that are contiguous with the outer wall of the developing frame 52.

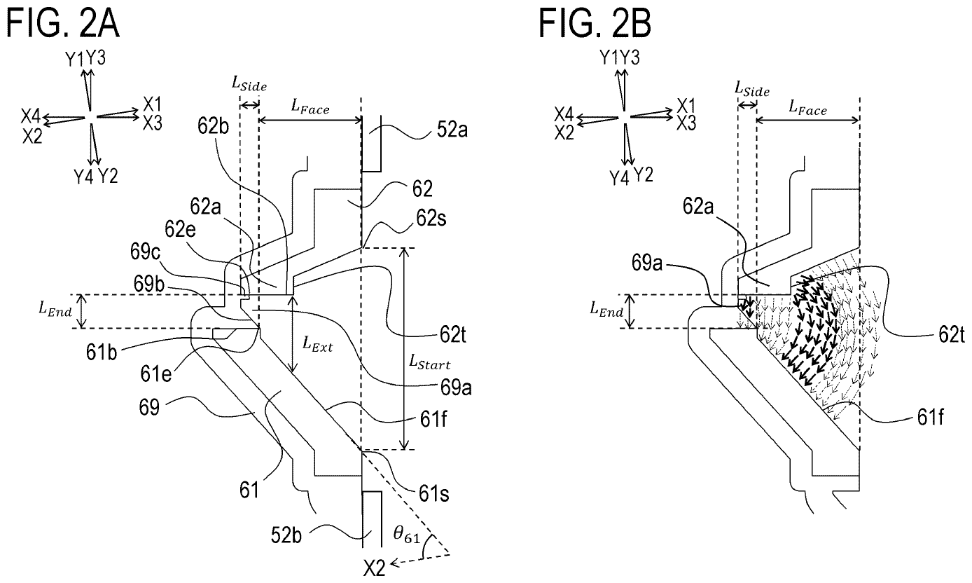

As shown in FIG. 2A, the first electrode 61 has, around the rotational axis of the stirring member 63, a first electrode start end 61s (first start end) that is distant from the second electrode 62 and a first electrode terminal end 61e (first terminal end) that is close to the second electrode 62. Similarly, the second electrode 62 has, around the rotational axis of the stirring member 63, a second electrode start end 62s (second start end) that is distant from the first electrode 61 and a second electrode terminal end 62e (second terminal end) that is close to the first electrode 61. The first electrode start end 61s, which is one end of the first electrode 61 in the detection capacitor closest approach directions Y3, Y4, is formed substantially coplanar with the detection capacitor connection wall surfaces 52a, 52b. Similarly, the second electrode start end 62s, which is one end of the second electrode 62 in the detection capacitor closest approach directions Y3, Y4, is also formed substantially coplanar with the detection capacitor connection wall surfaces 52a, 52b. Therefore, when the free end of the stirring sheet 63b follows the inner wall of the toner storage portion 60 to transport toner toward the detection capacitor C, in the detection capacitor closest vertical directions X3, X4, which are the intrusion directions of the stirring sheet 63b into the inner wall of the toner storage portion 60, the detection capacitor C, namely the first electrode 61 and the second electrode 62, are provided on the side farther from the free end of the stirring sheet 63b than the detection capacitor connection wall surfaces 52a, 52b. The detection capacitor connection first side wall 52c and detection capacitor connection second side wall 52d shown in FIG. 15 are formed in the same plane as the detection capacitor connection wall surfaces 52a, 52b shown in FIGS. 1, 2A and 2B. Thus, the relationship that the distance L_{Bond} between the stirring center and the detection capacitor connection inner wall is set shorter than the distance L_{Cap} between the stirring center and the detection capacitor start end, as mentioned above, is satisfied.

Furthermore, as shown in FIGS. 1 and 2A, the first electrode 61 has the first electrode terminal end 61e which is the other end side of the detection capacitor closest approach directions Y3, Y4. Additionally, the first electrode 61 has a first electrode exposed portion 61f formed between the first electrode start end 61s and the first electrode terminal end 61e. On the other hand, the second electrode 62 has the second electrode terminal end 62e which is the other end side of the detection capacitor closest approach directions Y3, Y4. Additionally, the second electrode 62 has an electrode protruding portion 62a, which is a protrusion protruding toward the first electrode 61 in the detection capacitor closest approach direction Y4, formed between the second electrode start end 62s and the second electrode terminal end 62e. The electrode protruding portion 62a is formed by the second electrode tip facing surface 62b having a normal in the detection capacitor closest approach directions Y3, Y4 and a second electrode shearing surface 62t having a normal in the detection capacitor closest vertical directions X3, X4. The second electrode tip facing surface 62b is an end surface of the second electrode terminal end 62e that extends substantially parallel to the rotational axis of the stirring member 63 and in the normal direction of the detection capacitor connection wall surfaces 52a, 52b, and is a surface substantially parallel to the first electrode tip facing surface 61b, which is an end surface of the first electrode terminal end 61e. The electrode protruding portion 62a is a corner portion of the second electrode 62 formed by the second electrode tip facing surface 62b and the second electrode shearing surface 62t contiguous therewith. Furthermore, when viewed in a direction orthogonal to the rotational axis of the stirring member 63 and along the detection capacitor connection wall surfaces 52a, 52b, the first electrode tip facing surface 61b and the second electrode tip facing surface 62b have regions that mutually overlap. The shortest distance between the first electrode 61 and the second electrode 62 in the same direction is formed between the first electrode tip facing surface 61b and the second electrode tip facing surface 62b. That is, the electrode start-end distance L_{Start} is the detection capacitor closest approach direction (Y3, Y4) distance between the first electrode start end 61s and the second electrode start end 62s in a direction orthogonal to the rotational axis of the stirring member 63 and along the detection capacitor connection wall surfaces 52a, 52b. In addition, the electrode terminal-end distance L_{End} is the detection capacitor closest approach direction (Y3, Y4) distance between the first electrode terminal end 61e and the second electrode terminal end 62e in the same direction. The electrode start-end distance L_{Start} is set longer than the electrode terminal-end distance L_{End}. The first electrode terminal end 61e and the second electrode terminal end 62e are disposed on the detection capacitor closest vertical direction X4 side relative to the first electrode start end 61s and the second electrode start end 62s, that is, on the side farther from the rotational axis center 63c of the stirring member 53. The electrode protruding portion distance L_{Ext}, which is the detection capacitor closest approach direction (Y3, Y4) distance between the electrode protruding portion 62a and the first electrode exposed portion 61f, is set between the electrode terminal-end distance L_{End} and the electrode start-end distance L_{Start}. From the perspectives of stabilizing the remaining amount detection signal V_{(SNS(t))} by ensuring the electrostatic capacity of the detection capacitor C and maintaining mass productivity by securing the strength of the detection capacitor mold core base portion 210, the electrode terminal-end distance L_{End} is set within a range of 1 mm to 2.5 mm.

The first electrode 61 and the second electrode 62 of the detection capacitor C face each other at their respective exposed portions within the detection capacitor facing region L_{Face}, which is the component in the detection capacitor closest vertical directions X3, X4 of the first electrode exposed portion 61f. On the other hand, in the detection capacitor non-facing region L_{side}, which is disposed adjacent to the detection capacitor facing region L_{Face} in the detection capacitor closest vertical direction X4, a first non-facing shielding wall 69b and a second non-facing shielding wall 69c are provided. The first non-facing shielding wall 69b and the second non-facing shielding wall 69c shield portions of the first electrode tip facing surface 61b and the second electrode tip facing surface 62b within the electrode terminal-end distance L_{End} region of the electrode holder 69 in the detection capacitor closest approach directions (Y3 and Y4). Specifically, the first non-facing shielding wall 69b is a wall portion (first wall portion) of the electrode holder 69 that contacts the first electrode tip facing surface 61b and protrudes toward a direction approaching the rotational axis of the stirring member 63 along the first electrode tip facing surface 61b. Similarly, the second non-facing shielding wall 69c is a wall portion (second wall portion) of the electrode holder 69 that contacts the second electrode tip facing surface 62b and protrudes toward a direction approaching the rotational axis of the stirring member 63 along the second electrode tip facing surface 62b. The first non-facing shielding wall 69b is arranged with a first electrode inclination angle θ₆₁, in the same manner as the first electrode exposed portion 61f. In addition, an electrode recessed portion 69a, which is a space capable of storing toner and is formed by the detection capacitor non-facing region L_{side}, the electrode terminal-end distance L_{End} region, the first non-facing shielding wall 69b, and the second non-facing shielding wall 69c, is provided between the first electrode 61 and the second electrode 62. The electrode recessed portion 69a is recessed in a direction away from the rotational axis of the stirring member 63 between the first non-facing shielding wall 69b and the second non-facing shielding wall 69c. The first electrode 61 and the second electrode 62 are arranged electrically non-contacting by the electrode recessed portion 69a having a gap of the electrode terminal-end distance L_{End}, thereby forming the detection capacitor C.

The first electrode exposed portion 61f, which is the exposed portion of the first electrode 61 in the toner storage portion (storage chamber) 60, is arranged with a first electrode inclination angle θ61 set larger than the angle of repose of toner. Therefore, after the stirring sheet 63b passes through the detection capacitor C in the detection capacitor closest approach direction Y3, toner on the first electrode 61 falls downward in the vertical direction Y2 under the influence of gravity. For this reason, in the toner entry and exit movement into and out of the detection capacitor C caused by the rotation of the stirring member 63 shown in FIG. 1, it is possible to prevent toner that has entered between the first electrode 61 and the second electrode 62 from remaining there. Furthermore, the inter-electrode distances of the detection capacitor, namely, the electrode protruding portion distance L_{Ext}, the electrode terminal-end distance L_{End}, and the electrode start-end distance L_{Start}, are each formed by the conductive two-color molding of the remaining amount detection member Z shown in FIGS. 11A to 13B. The inter-electrode distance, which is a characteristic factor of the electrostatic capacity of the detection capacitor C, is determined by the mold precision of the two-color molding and the control of molding conditions. Therefore, compared to cases where capacitor electrodes are provided by assembling or bonding of multiple components, variations due to fitting play during assembly or positional tolerances during bonding can be eliminated. By suppressing the tolerance of the inter-electrode distance, the amplitude ΔV in the remaining amount detection signal V_{(SNS(t))} becomes more stable, enabling high-accuracy toner remaining amount detection.

As shown in FIG. 2B, an electric field forming electrostatic capacity is generated between the first electrode 61 and the second electrode 62. Since the electrode protruding portion 62a is provided on the second electrode 62, the edge effect of electric lines of force generated from the second electrode shearing surface 62t of the electrode protruding portion 62a is taken into account. Due to the edge effect, the electrostatic capacity of the detection capacitor C increases compared to when the electrode protruding portion 62a is absent. The increase in electrostatic capacity leads to an increase in amplitude ΔV in the remaining amount detection signal V_{(SNS(t))}, enabling high-accuracy toner remaining amount detection.

In addition, the detection capacitor C, i.e., the first electrode 61 and the second electrode 62, is arranged on the side farther from the free end 63d of the stirring sheet 63b with respect to the second wall surface 59 shown in FIGS. 1 and 15, that is, in a recess-side configuration. Furthermore, both side end portions (63f, 63g (not shown)) of the stirring sheet 63b in the longitudinal directions Z1, Z2 are disposed outside the first side wall 30 and the second side wall 31 within the detection capacitor C. That is, the width Wc (the facing distance between the first side wall 30 and the second side wall 31) of the recessed portion 58 in the longitudinal directions Z1, Z2 (first direction) is narrower than the width Ws of the stirring sheet 63b in the same direction, and the recessed portion 58 is positioned within the region between both ends of the stirring sheet 63b in the same direction (see FIG. 15). Therefore, after the free end 63e of the stirring sheet 63b passes while in contact with the first wall surface 57 and subsequently passes through the region of the detection capacitor C, the free end 63e of the stirring sheet 63b always remains in contact with the second wall surface 59, preventing the free end 63e of the stirring sheet 63b from being released and causing toner to scatter. Therefore, since toner can be stably fed to the detection capacitor C, high-accuracy toner remaining amount detection becomes possible. Furthermore, when providing a slit in the free end 63d of the stirring sheet 63b, by not placing the slit within the region inside the first side wall 30 and the second side wall 31 of the detection capacitor in the longitudinal directions Z1, Z2, the same effect can be achieved.

The first non-facing shielding wall 69b and the second non-facing shielding wall 69c are disposed opposing each other via the electrode recessed portion 69a in the detection capacitor closest approach directions Y3, Y4. Therefore, during injection of the conductive resin, which is the second material of the conductive two-color molding shown in FIG. 12B, leakage of the conductive resin of the first electrode 61 and the second electrode 62 through the gap between the detection capacitor mold core base portion 210 and the electrode holder 69 is prevented by a labyrinth effect. By preventing resin leakage, stable electrical insulation between the first electrode 61 and the second electrode 62 can be achieved, thereby enabling the mass productivity of conductive two-color molding to be ensured. Moreover, in the detection capacitor non-facing region L_{side}, although the first electrode 61 and the second electrode 62 are not arranged opposing each other in an exposed state, the provision of the electrode recessed portion 69a causes electric lines of force to be generated. In addition, since the electrode recessed portion 69a can form a minute gap equal to or less than the electrode terminal-end distance L_{End}, it can form the strongest electric field in the detection capacitor C. As a result, the electrostatic capacity of the detection capacitor C increases compared to when the electrode recessed portion 69a is absent, enabling high-accuracy toner remaining amount detection due to an increase in amplitude ΔV, similar to the case of the electrode protruding portion 62a.

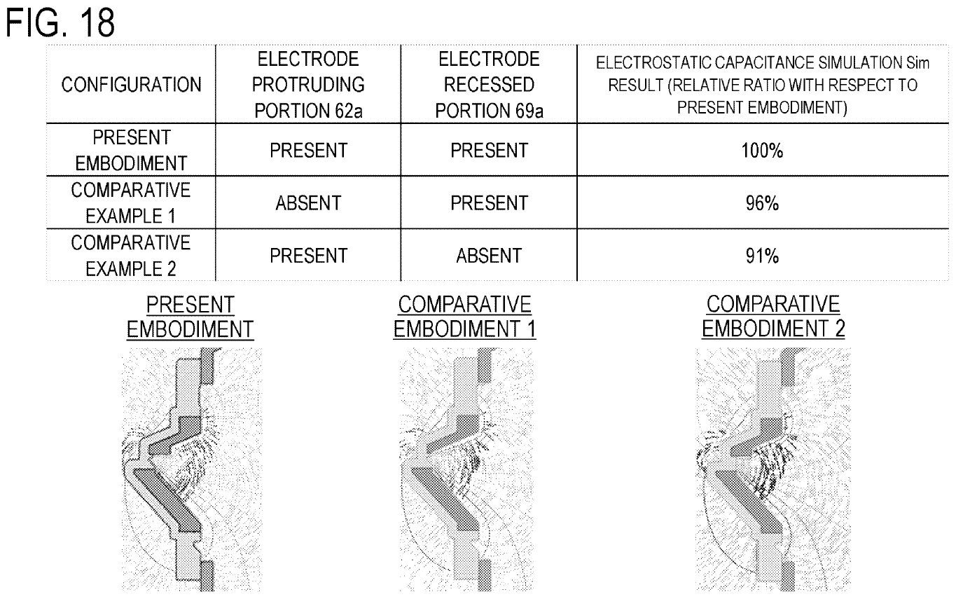

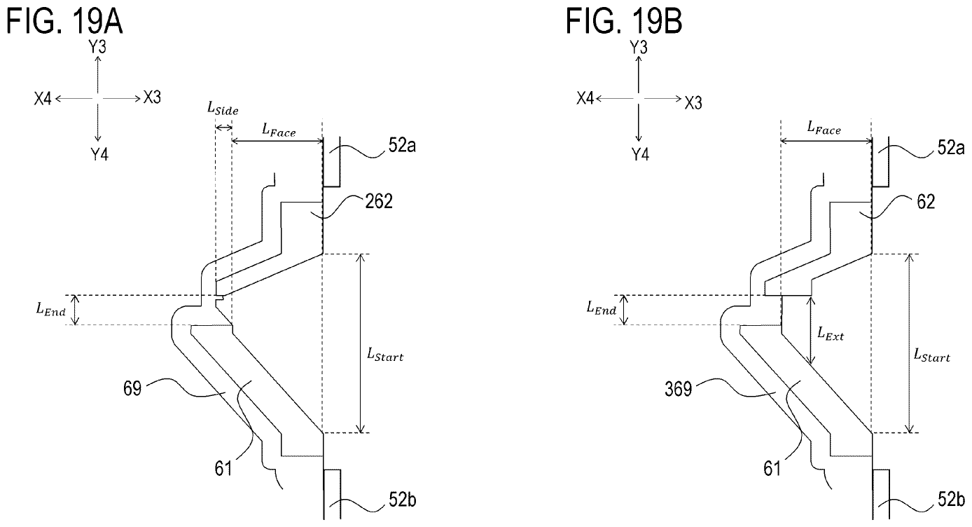

The effects of the present embodiment based on electrostatic capacity simulation will be described with reference to FIGS. 18, 19A and 19B. FIGS. 19A and 19B are comparative examples of the detection capacitor C relative to the present embodiment. FIG. 18 shows the of electrostatic capacitance simulation results for the present embodiment and the comparative examples shown in FIGS. 19A and 19B. A second electrode 262 of Comparative Embodiment 1 shown in FIG. 19A has a configuration in which the electrode protruding portion 62a is removed from the second electrode 62 of the present embodiment. On the other hand, the electrode holder 369 of Comparative Embodiment 2 shown in FIG. 19B has a configuration in which the electrode recessed portion 69a is removed from the electrode holder 69 of the present embodiment. As shown in the electrostatic capacitance simulation results in FIG. 18, the present embodiment (with electrode protruding portion 62a) achieves approximately a 4% improvement in electrostatic capacity compared to Comparative Embodiment 1 (without electrode protruding portion 62a) and approximately a 9% improvement compared to Comparative Embodiment 2 (without electrode recessed portion 69a).

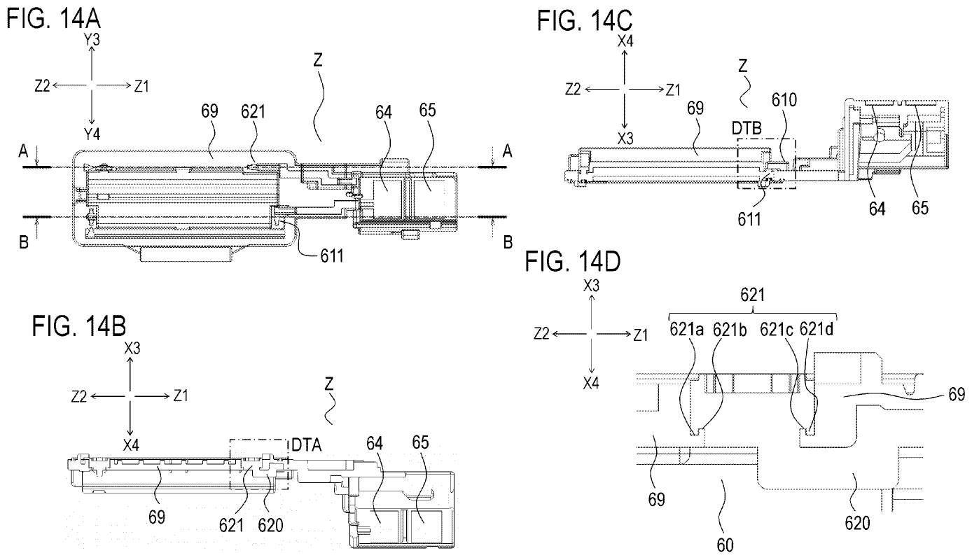

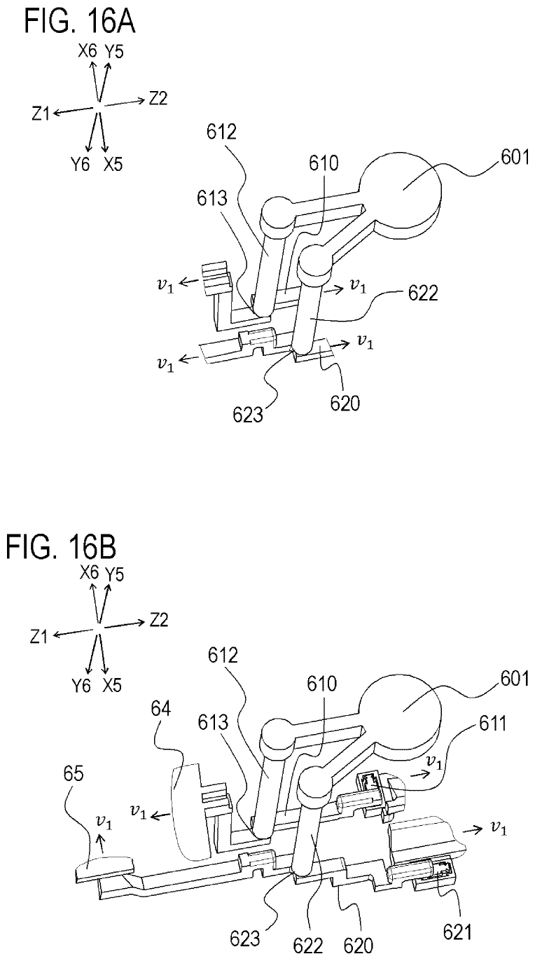

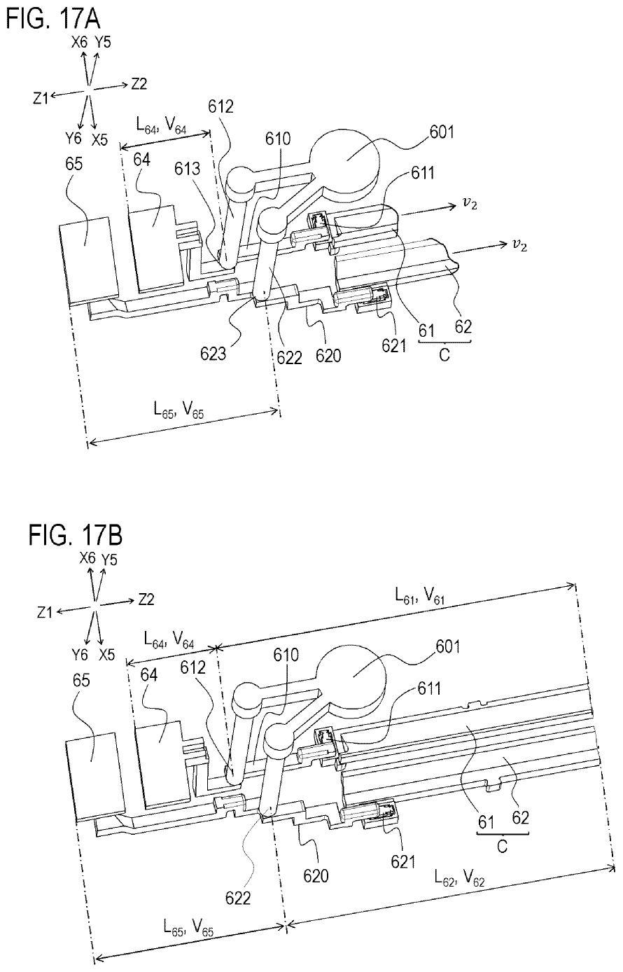

The conductive resin configuration of the remaining amount detection member Z will be described with reference to FIGS. 6A, 6B and FIGS. 14A to 14D, 16A, 16B, 17A and 17B. FIG. 14A is a front view showing the configuration of the remaining amount detection member Z. FIGS. 14B and 14C are longitudinal cross-sectional views showing the toner sealing configuration of FIG. 14A, respectively. FIG. 14D is a detailed view of the toner sealing configuration shown in FIGS. 14B and 14C. FIGS. 16A, 16B, 17A and 17B are explanatory diagrams of the resin flow passage and gate arrangement configuration in the conductive resin molding of the detection capacitor C and the electrical contacts 64, 65.

As shown in FIGS. 14A, 6A and 6B, the remaining amount detection member Z is an electrostatic capacity type toner remaining amount detection signal detection member composed of the electrode holder 69, the detection capacitor C, and the electrical contacts 64, 65, and is manufactured by means of the conductive two-color molding shown in FIGS. 11A to 13B. As shown in FIG. 14C, the first electrical contact 64 and the first electrode 61 are integrally molded via a first electrode flow passage 610 and a first electrode toner sealing portion 611 during the conductive resin molding process shown in FIG. 12B, and therefore they are electrically connected. As shown in FIG. 14B, the second electrical contact 65 and the second electrode 62 are also integrally molded via a second electrode flow passage 620 and the second electrode toner sealing portion 621 during the conductive resin molding process shown in FIG. 12B, and therefore they are electrically connected. Furthermore, the conductive resin in the present embodiment is formed from conductive POM composed of polyacetal (POM) containing approximately 10% carbon black (hereinafter referred to as CB). The insulating resin of the electrode holder 69 is PS+PPE resin, but it is not limited to this.

As shown in FIG. 14D, the second electrode flow passage 620 and the second electrode toner sealing portion 621 are integrally molded with conductive resin and are integrally bonded to the electrode holder 69. Since the first electrode flow passage 610 and the first electrode toner sealing portion 611 have a similar configuration, the toner sealing configuration using the second electrode toner sealing portion 621 and the second electrode flow passage 620 will be explained here.

The second electrode toner sealing portion 621 is composed of second electrode toner sealing protruding portions 621a, 621d and second electrode toner sealing recessed portions 621b, 621c. The second electrode toner sealing protruding portions 621a, 621d are disposed on the longitudinal direction (Z1, Z2) outer side relative to the second electrode toner sealing recessed portions 621b, 621c and in the detection capacitor closest vertical direction X4, which is the side toward the toner storage portion 60. In other words, the second electrode toner sealing recessed portions 621b, 621c are positioned on the longitudinal direction (Z1, Z2) inner side relative to the second electrode toner sealing protruding portions 621a, 621d and in the detection capacitor closest vertical direction X3, which is the side away from the toner storage portion 60.

The electrical contacts 64, 65 and the detection capacitor C are molded according to the flow shown in FIGS. 16A, 16B, 17A and 17B. First, as shown in FIG. 16A, the conductive resin injected from an injection molding machine (not shown) at a predetermined injection velocity into a runner 601 branches into a first electrode gate portion 612 and a second electrode gate portion 622. The conductive resin flowing through the first electrode gate portion 612 begins to flow into the first electrode flow passage 610 via a first gate connection portion 613. Similarly, the conductive resin flowing through the second electrode gate portion 622 begins to flow into the second electrode flow passage 620 via a second gate connection portion 623. The first gate connection portion 613 is an inlet for the conductive resin provided midway along the first electrode flow passage 610, which serves as a conductive path connecting the first electrode 61 and the first electrical contact 64. The second gate connection portion 623 is an inlet for the conductive resin provided midway along the first electrode flow passage 610, which serves as a conductive path connecting the second electrode 62 and the second electrical contact 65. Next, as shown in FIG. 16B, the first electrode flow passage 610 and the second electrode flow passage 620 branch toward the longitudinal direction Z1, which is the side toward the electrical contacts 64, 65, and the longitudinal direction Z2, which is the side toward the detection capacitor C, respectively. Furthermore, as shown in FIG. 17A, the conductive resin on the longitudinal direction Z2 side flows beyond the first electrode toner sealing portion 611 and the second electrode toner sealing portion 621 into a part of the detection capacitor C. At this stage, the conductive resin on the longitudinal direction Z1 side is filled by the amounts corresponding to the first electrical contact molding distance L₆₄ and the second electrical contact molding distance L₆₅, respectively, completing the filling of electrical contacts 64, 65. The resin filling volume from each gate (each gate connection portion 613, 623) to the electrical contacts 64, 65 at this time is defined as the first electrical contact molding volume V₆₄ and the second electrical contact molding volume V₆₅, respectively. Furthermore, as shown in FIG. 17A, the conductive resin injected from the injection molding machine (not shown) into the runner 601 at a predetermined injection velocity is not branched into the longitudinal direction Z1, which is the side toward the electrical contacts 64, 65, in the first electrode flow passage 610 and the second electrode flow passage 620, but is filled only toward the longitudinal direction Z2, which is the side toward the detection capacitor C. Therefore, according to the law of flow rate, compared to the pre-electrical-contact-forming flow velocity v₁, which is the flow velocity up to the molding of the electrical contacts 64, 65 as shown in FIGS. 16A and 16B, the post-electrical-contact-forming flow velocity v₂, which is the flow velocity from after the molding of the electrical contacts 64, 65 as shown in FIG. 17A until the completion of molding the detection capacitor C, is higher than the pre-electrical-contact-forming flow velocity v₁. Finally, as shown in FIG. 17B, when the molding of the detection capacitor C is completed, the conductive resin on the longitudinal direction Z2 side is filled by the amounts corresponding to the first electrode molding distance L₆₁ and the second electrode molding distance L₆₂, respectively. The resin filling volume from each gate to the detection capacitor C at this time is defined as the first electrode molding volume V₆₁ and the second electrode molding volume V₆₂, respectively. To satisfy the relationship where the pre-electrical-contact-forming flow velocity v₁ is less than the post-electrical-contact-forming flow velocity v₂, the first electrode gate portion 612 and the second electrode gate portion 622 are each arranged so as to satisfy the following relational expressions:
First electrical contact molding volume V₆₄<first electrode molding volume V₆₁
Second electrical contact molding volume V₆₅<second electrode molding volume V₆₂

In the remaining amount detection member Z of the present embodiment, during the conductive two-color molding, the second electrode toner sealing protruding portions 621a, 621d tighten toward the longitudinal direction Z1, Z2 inner side of the second electrode toner sealing recessed portions 621b, 621c due to molding shrinkage, thereby sealing the toner inside the toner storage portion 60. Here, if the material of the developing frame 52 shown in FIG. 1 is set to a PS-based resin, compatibility with the electrode holder 69 can be obtained. Therefore, it becomes possible to join by methods such as ultrasonic welding or heat staking without using other materials such as adhesive or tape in terms of ensuring strength, reducing cost, and reducing environmental load. Furthermore, since the first electrical contact 64, the first electrode 61, the first electrode flow passage 610, and the first electrode toner sealing portion 611 are all integrated by conductive two-color molding, there is no contact resistance between these elements, resulting only in internal resistance. Similarly, there is also no contact resistance between the elements of the second electrical contact 65, the second electrode 62, the second electrode flow passage 620, and the second electrode toner sealing portion 621, resulting only in internal resistance. Therefore, compared to a configuration where the electrical contacts 64, 65 and the detection capacitor C are provided as separate components and electrically connected, the absence of contact resistance between components makes it possible to suppress the parasitic resistance R, which is a factor in the attenuation of the remaining amount detection signal V_{(SNS(t))}.

Furthermore, in the remaining amount detection member Z of the present embodiment, the relationship where the pre-electrical-contact-forming flow velocity v₁ is less than the post-electrical-contact-forming flow velocity v₂ is satisfied, thereby allowing the injection velocity of the conductive resin at electrical contacts 64, 65 to be kept low. By keeping the injection velocity of the conductive resin low, the shear-induced breakdown of CB contained in the conductive resin is suppressed on the surface of the electrical contacts 64, 65 formed by the skin layer with the mold. As a result, the conductive effect provided by the CB is maintained even after molding. Consequently, by preventing an increase in the surface resistance of the electrical contacts 64, 65, the contact resistance with the electrical contact springs 90, 91 shown in FIGS. 8A, 8B, and FIGS. 9A to 9C is suppressed. This makes it possible to reduce the parasitic resistance R, which is a factor in the attenuation of the remaining amount detection signal V_{(SNS(t))}. On the other hand, the surface resistance in the detection capacitor C, which is filled at the post-electrical-contact-forming flow velocity v₂, becomes higher than the surface resistance of the electrical contacts 64, 65 due to the shear-induced breakdown of CB. This results from the relationship where the pre-electrical-contact-forming flow velocity v₁ dis less than the post-electrical-contact-forming flow velocity v₂. However, since the detection capacitor C is configured solely to detect changes in electrostatic capacity caused by the entry and exit of toner within the toner storage portion 60 as a capacitive reactance, an increase in the surface resistance of the detection capacitor C does not become a factor in the attenuation of the remaining amount detection signal V_{(SNS(t))}. Therefore, in the integrated configuration including the electrical contacts 64, 65 and the detection capacitor C formed from conductive resin, it is configured to keep the injection velocity of the conductive resin at the electrical contacts 64, 65 lower than at other filling locations. This is done in order to minimize the surface contact resistance, which forms a part of the parasitic resistance R.

According to the present disclosure, it is possible to advance the development of a cartridge or an electrophotographic image forming apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-035941, filed on Mar. 6, 2025, which is hereby incorporated by reference herein in its entirety.

What is claimed is:

1. A developing apparatus, comprising:
a frame having a storage portion that stores developer and having insulating properties;
a first electrode portion and a second electrode portion that are inside the storage portion and exposed from the frame to an inside of the storage portion, the first electrode portion and the second electrode portion being disposed so as to face each other;
a stirring member having: a rotation shaft that rotates about a rotational axis extending in a first direction; and a sheet having a fixed end that is an end portion of the sheet in a second direction orthogonal to the first direction is fixed to the rotation shaft and a free end that is an end portion opposite to the fixed end in the second direction, a length of the sheet from the fixed end to the free end is a length capable of contacting an inner wall of the frame that forms the storage portion;
a first conductive member having the first electrode portion and a first electrical contact portion, the first electrical contact portion being connected to the first electrode portion and exposed to an outside of the storage portion; and
a second conductive member having the second electrode portion and a second electrical contact portion, the second electrical contact portion being connected to the second electrode portion and exposed to the outside of the storage portion;
wherein a part of the inner wall of the frame has a recessed portion that is recessed in a direction away from the rotation shaft in the second direction;
wherein the first electrode portion and the second electrode portion are provided in the recessed portion;
wherein a width of the recessed portion in the first direction is narrower than a width of the sheet in the first direction, and the recessed portion is positioned within a region between both ends of the sheet in the first direction; and
wherein the first conductive member and the second conductive member are integrally molded with the frame by injecting conductive resin with respect to the frame.

2. The developing apparatus according to claim 1,
wherein the first electrode portion is provided on an upstream side of the recessed portion in a rotation direction of the rotation shaft; and
wherein the second electrode portion is provided on a downstream side of the recessed portion in the rotation direction.

3. The developing apparatus according to claim 2,
wherein the first electrode portion has a shape that, when viewed in the first direction, becomes farther from the rotation shaft in the rotation direction; and
wherein the second electrode portion has a shape that, when viewed in the first direction, becomes closer to the rotation shaft in the rotation direction.

4. The developing apparatus according to claim 3,
wherein the recessed portion includes a first side wall and a second side wall which oppose with each other in the first direction; and
wherein the first electrode portion and the second electrode portion are respectively provided between the first side wall and the second side wall such that the first direction is a longitudinal direction.

5. The developing apparatus according to claim 1,
wherein the frame includes:
a developing chamber that communicates with the storage portion via an opening; and
a developing roller disposed in the developing chamber;
wherein the inner wall of the frame includes:
a first wall surface on which the opening is provided; and
a second wall surface that is contiguous with the first wall surface on a downstream side in the rotation direction of the rotation shaft, and on which the recessed portion is provided;
wherein the length of the sheet from the fixed end to the free end is a length capable of contacting at least the first wall surface and the second wall surface.

6. The developing apparatus according to claim 1,
wherein the frame includes a first part and a second part, the first part rotatably supports the rotation shaft, the second part is configured separately from the first part, is provided with the recessed portion, and is integrally molded with the first conductive member and the second conductive member.
